(19) United States
(12) Patent Application Publication
(10) Pub. No.: US 2024/0322863 A1
(43) Pub. Date: Sep. 26, 2024

(54) SINGLE-POINT BEAM FOCUSING FOR RIS

(71) Applicant: QUALCOMM Incorporated, San Diego, CA (US)

(72) Inventors: Yavuz YAPICI, Florham Park, NJ (US); Narayan PRASAD, Westfield, NJ (US); Tao LUO, San Diego, CA (US); Junyi LI, Fairless Hills, PA (US)

(21) Appl. No.: 18/188,416

(22) Filed: Mar. 22, 2023

(51) Int. Cl. H04B 7/04; H04B 7/06

(52) U.S. Cl. CPC H04B 7/04013; H04B 7/06952

(57) ABSTRACT

A network device, such as a base station or a RIS, obtains an indication of a characteristic distance associated with a configurable array of reflective elements. The network device provides a communication for a wireless device using a beam focusing configuration of the configurable array of reflective elements with a first focusing distance based on the characteristic distance.

### TECHNICAL FIELD

The present disclosure relates generally to communication systems, and more particularly, to communication via a beam-shaping reconfigurable intelligent surface (RIS).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP™) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a network device such as a base station or a RIS (including a configurable array of reflective elements and a controller) that may be configured to obtain an indication of a characteristic distance associated with a configurable array of reflective elements. The apparatus may also be configured to provide a communication for a wireless device using a beam focusing configuration of the configurable array of reflective elements with a first focusing distance based on the characteristic distance.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 illustrates diagrams showing various aspects of communication via a RIS to avoid a blockage, in accordance with various aspects of the present disclosure.

FIG. 5 illustrates a diagram illustrating various aspects of communication via a RIS, in accordance with various aspects of the present disclosure.

FIG. 6 illustrates an example power curve for transmissions from a RIS, in accordance with various aspects of the present disclosure.

FIG. 7 illustrates example aspects of beam focusing by a RIS, in accordance with various aspects of the present disclosure.

FIG. 8 illustrates example aspects of beam focusing by a RIS, in accordance with various aspects of the present disclosure.

FIG. 9 illustrates example aspects of beam focusing by a RIS, in accordance with various aspects of the present disclosure.

FIG. 10 is an example communication flow between a base station and a UE via a RIS, in accordance with various aspects of the present disclosure.

FIG. 11 is a flowchart of a method of wireless communication, in accordance with various aspects of the present disclosure.

FIG. 12 is a flowchart of a method of wireless communication, in accordance with various aspects of the present disclosure.

FIG. 13 is a flowchart of a method of wireless communication, in accordance with various aspects of the present disclosure.

FIG. 14 is a flowchart of a method of wireless communication, in accordance with various aspects of the present disclosure.

FIG. 15 is a flowchart of a method of wireless communication, in accordance with various aspects of the present disclosure.

FIG. 16 is a diagram illustrating an example of a hardware implementation for an example network entity, in accordance with various aspects of the present disclosure.

FIG. 17 is a diagram illustrating an example of a hardware implementation for an example network entity, in accordance with various aspects of the present disclosure.

### DETAILED DESCRIPTION

In some aspects of wireless communication, a network may include a RIS used to circumvent blockages between a base station and a wireless device (e.g., a UE) that the base station serves. In some contexts, a RIS may also be referred to as one of a meta-surface, a smart surface, or an intelligent reflection surface(s) (IRS) and may be related to, or incorporate, meta-devices, or meta-materials (e.g., tunable, active, passive, or programmable meta-materials), and may be distinguished from a reflectarray (e.g., a non-reconfigurable, or static, reflecting surface). A RIS, in some aspects, is an array of reconfigurable reflecting elements that may, in some implementations, include passive and/or active reflecting elements. The RIS may be used to improve spectral efficiency at low deployment cost. However, RIS-assisted links (links from a base station to a UE via a RIS) may experience a near-field effect since the effective aperture size of a RIS is generally large compared to classical transmit arrays. In some aspects, a RIS may perform a beam focusing operation, e.g., an operation that includes both steering a beam towards a direction and also focusing the beam at a specific distance (e.g., using a specific focusing distance), to increase a received power at a UE. In order to achieve the most benefit from beam focusing it is useful to know the distance from the RIS to the UE for which the beam focusing is performed.

Although a transmitter-to-RIS distance may be relatively stable and may be known by each transmitter using the RIS, the highly-variable RIS-to-receiver distance may not be known (e.g., available to the transmitter, the RIS, a RIS controller, or a receiver such as a UE). The RIS-to-receiver distance may particularly not be available, or known, during initial communication over cascaded transmitter-RIS-receiver links, accordingly, this may present challenges which makes beam focusing applications difficult due to the lack of the distance information (for determining an optimal focusing distance i.e., a distance at which the signal power for a target is to be optimized, which in some aspects, may alternatively be referred to as, or be related to, a focal distance or focal length).

Various aspects relate generally to allowing a base station to serve a set of wireless devices distributed over a long range of distances using a single RIS configuration for beam focusing (e.g., a single beam focusing beam). Some aspects more specifically relate to using a fixed-focus, or single-receive-point, beam focusing configuration of a RIS for reflecting, or shaping a beam for, communication between the base station and a plurality of wireless devices at a plurality of distances from the RIS. For example, in some aspects disclosed herein, a network device may obtain an indication of a characteristic distance associated with a configurable array of reflective elements (e.g., a RIS or a component of a network device including the RIS/configurable array of reflective elements and a RIS controller). The characteristic distance associated with the configurable array of reflective elements may be used to determine a first focusing distance (e.g., a distance or location associated with a beam focusing operation). The determination in some aspects, is associated with a set of stable and ascertainable characteristics of the RIS and a base station using the RIS for communication with a set of wireless devices (e.g. UEs). Accordingly, the base station and the RIS may serve at least one wireless device based on a beam focusing configuration associated with the first focusing distance without consuming time and/or frequency resources to determine a distance between the RIS and the at least one wireless device. In some aspects, the characteristics of the RIS and the base station may further be used to determine a threshold distance (e.g., associated with, or defining, a near-field boundary) at which the beam focusing no longer provides greater power than a beamforming (which is only steering beam to desired direction, so needs only angle/direction information of the receiver) operation (or configuration of the RIS) and the base station and the RIS may serve at least one wireless device based on a beamforming configuration if the wireless device is determined to be farther than the threshold distance associated with the first focusing distance. While there is some distance determination occurring, the amount of resources used to obtain a coarse and/or rough estimate of distance associated with a binary determination (e.g., within a threshold distance or farther than a threshold distance) may be significantly less than the resources used to obtain a fine-grained and/or more accurate estimate of distance used for a UE-specific beam focusing operation. Accordingly, aspects disclosed herein may provide a reduced-complexity application of beam focusing that increase a received power at a set of wireless devices when compared with beamforming without incurring the additional overhead costs associated with accurate distance determination for cascaded transmitter-RIS-receiver links.

Particular aspects of the subject matter described in this disclosure can be implemented to realize one or more of the following potential advantages. In some examples, by using a single beam focusing beam, and an, associated single RIS configuration, for a plurality of UEs at different distances, the base station may conserve resources that might otherwise be consumed and/or wasted by gaps between communication with a first UE and a second UE to reconfigure a RIS for different beam focusing distances. The aspects described herein may also result in an increase in received power for UEs or wireless devices in a near-field while maintaining a received power for UEs in a mid-to far-field. Additionally, different aspects described herein, may provide opportunity to select to optimize performance of the configuration(s) or to select to reduce the complexity of the configuration at the expense of slightly reducing the performance of the configuration.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

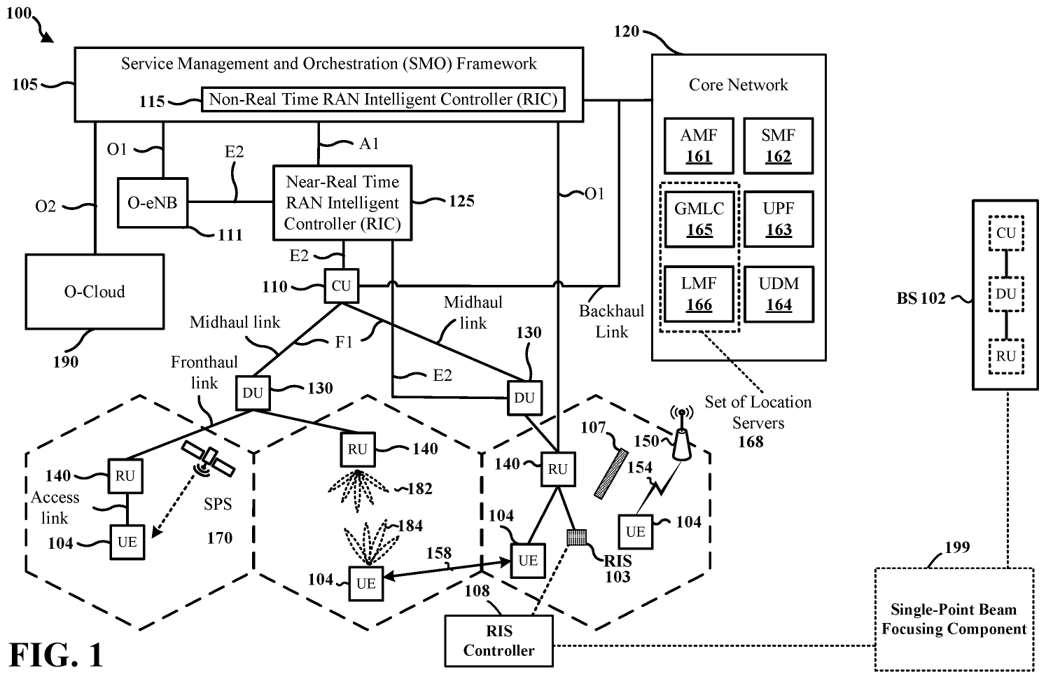

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some aspects, the network may include a reconfiguration intelligent surface (RIS) 103 that may reflect beamformed (or beam-focused) communication between the RU 140 and a UE 104 to avoid a blockage 107 that blocks a directional beam between the RU 140 (or an associated base station 102) and the UE 104. A RIS is one example of a name for a passive array that reflects or refracts communication between a base station and a UE to control an angle of reflection, e.g., without decoding the communication. In other examples, the RIS may be called a meta-surface, a smart surface, or an IRS and may be related to, or incorporate, meta-devices, or meta-materials (e.g., tunable, active, passive, or programmable meta-materials). The RIS 103 may be associated with a RIS controller 108. Discovery information, such as RIS capability information and/or position information for the RIS 103 may be transmitted by the RIS controller 108, e.g., to a UE 104 via sidelink or to a base station via uplink. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP™. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell). Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™, Wi-Fi™ based on the Institute of Electrical and Electronics Engineers (IEEE) 802.11 standard, LTE, or NR.

The wireless communications system may further include a Wi-Fi™ AP 150 in communication with UEs 104 (also referred to as Wi-Fi™ stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHZ-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHZ) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHZ-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth™ signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the base station 102, or a RIS controller 108, may have a single-point beam focusing component 199 that may be configured to obtain an indication of a characteristic distance associated with a configurable array of reflective elements. The single-point beam focusing component 199 may also be configured to provide a communication for a wireless device using a beam focusing configuration of the configurable array of reflective elements with a first focusing distance based on the characteristic distance. While the discussion below may focus on wireless communication associated with 5G NR, some aspects may be applicable to other wireless communication technologies.

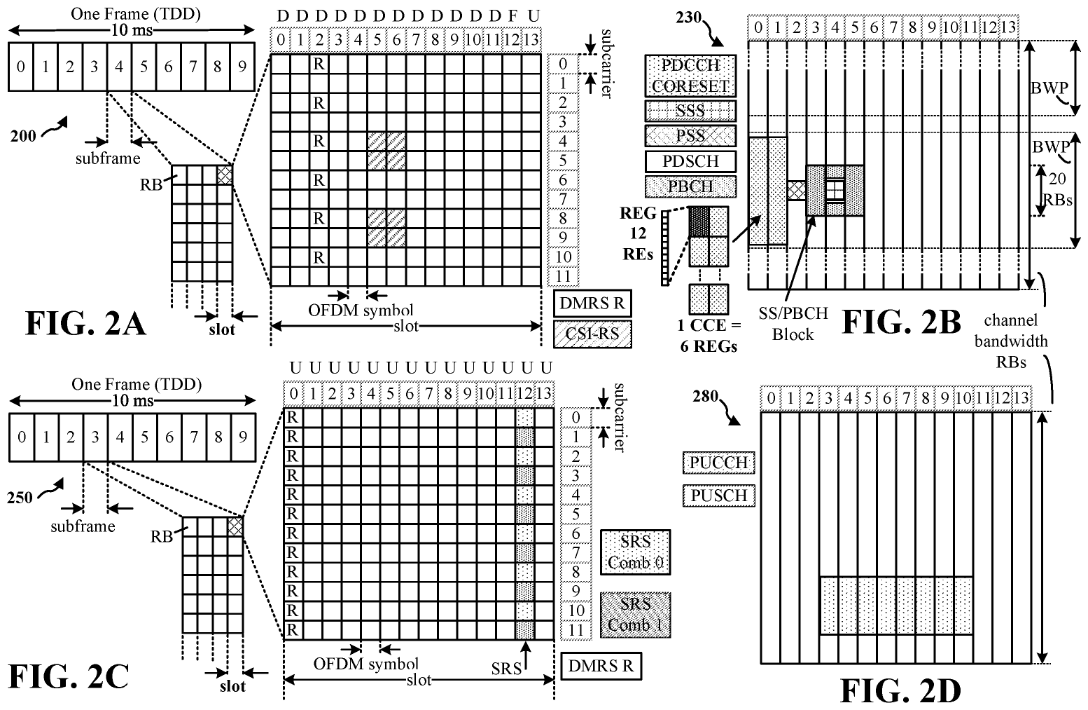

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A. 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 18 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 18.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 18 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

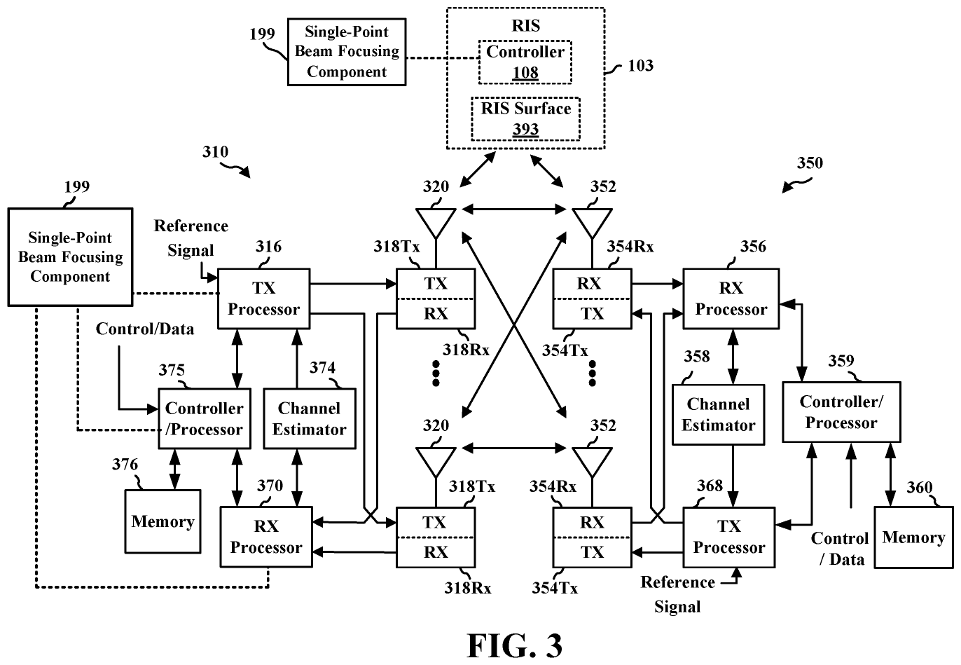

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antennas 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

FIG. 3 illustrates an example of a RIS 103 that is configured to reflect communication between the base station 310 and the UE 350. The RIS 103 includes a RIS surface 393 of elements that are reconfigurable for different incident angles and reflection angles. The RIS 103 may also include a RIS controller 108 that controls the reflection coefficients of the RIS surface 393 to adjust the angles, e.g., as described in connection with FIG. 1. In some aspects, the RIS controller 108 may include communication components, e.g., including Tx processor, and Rx processor, and/or a controller processor, such as described for the base station 310 and/or UE 350, in order to receive control signaling regarding the control of the RIS surface 393.

At least one of the TX processor 316, the RX processor 370, and the controller/processor 375 may be configured to perform aspects in connection with the single-point beam focusing component 199 of FIG. 1.

In some aspects of wireless communication, a network may include a RIS used to circumvent blockages between a base station and a wireless device (e.g., a UE) that the base station serves. A RIS, in some aspects, is an array of reconfigurable reflecting elements that may, in some implementations, include passive and/or active reflecting elements. The RIS may be used to improve spectral efficiency at low deployment cost. However, RIS-assisted links (links from a base station to a UE via a RIS) may experience a near-field effect since the effective aperture size of a RIS is generally large compared to classical transmit arrays. In some aspects, a RIS may perform a beam focusing operation, e.g., an operation that includes both steering a beam towards a direction and also focusing the beam at a specific distance (e.g., using a specific focusing distance), to increase a received power at a UE. In order to achieve the most benefit from beam focusing it is useful to know the distance from the RIS to the UE for which the beam focusing is performed.

Although a transmitter-to-RIS distance may be relatively stable and may be known by each transmitter using the RIS, the highly-variable RIS-to-receiver distance may not be known (e.g., available to the transmitter, the RIS, a RIS controller, or a receiver such as a UE). The RIS-to-receiver distance may particularly not be available, or known, during initial communication over cascaded transmitter-RIS-receiver links, accordingly, this may present challenges which makes beam focusing applications difficult due to the lack of the distance information (for determining an optimal focusing distance).

Various aspects relate generally to allowing a base station to serve a set of wireless devices distributed over a long range of distances using a single RIS configuration for beam focusing (e.g., a single beam focusing beam). Some aspects more specifically relate to using a fixed-focus, or single-receive-point, beam focusing configuration of a RIS for reflecting, or shaping a beam for, communication between the base station and a plurality of wireless devices at a plurality of distances from the RIS. For example, in some aspects disclosed herein, a network device may obtain an indication of a characteristic distance associated with a configurable array of reflective elements (e.g., a RIS or a component of a network device including the RIS/configurable array of reflective elements and a RIS controller). The characteristic distance associated with the configurable array of reflective elements may be used to determine a first focusing distance (e.g., a distance or location associated with a beam focusing operation). The determination in some aspects, is associated with a set of stable and, in some aspects, easily-ascertainable characteristics of the RIS and a base station using the RIS for communication with a set of wireless devices (e.g. UEs). Accordingly, the base station and the RIS may serve at least one wireless device based on a beam focusing configuration associated with the first focusing distance without consuming time and/or frequency resources to determine a distance between the RIS and the at least one wireless device. In some aspects, the characteristics of the RIS and the base station may further be used to determine a threshold distance (e.g., associated with, or defining, a near-field boundary) at which the beam focusing no longer provides greater power than a beamforming operation (or configuration of the RIS) and the base station and the RIS may serve at least one wireless device based on a beamforming configuration if the wireless device is determined to be farther than the threshold distance associated with the first focusing distance. While there is some distance determination occurring, the amount of resources used to obtain a coarse and/or rough estimate of distance associated with a binary determination (e.g., within a threshold distance or farther than a threshold distance) may be significantly less than the resources used to obtain a fine-grained and/or more accurate estimate of distance used for a UE-specific beam focusing operation. Accordingly, aspects disclosed herein may provide a reduced-complexity application of beam focusing that increase a received power at a set of wireless devices when compared with beamforming without incurring the additional overhead costs associated with accurate distance determination for cascaded transmitter-RIS-receiver links.

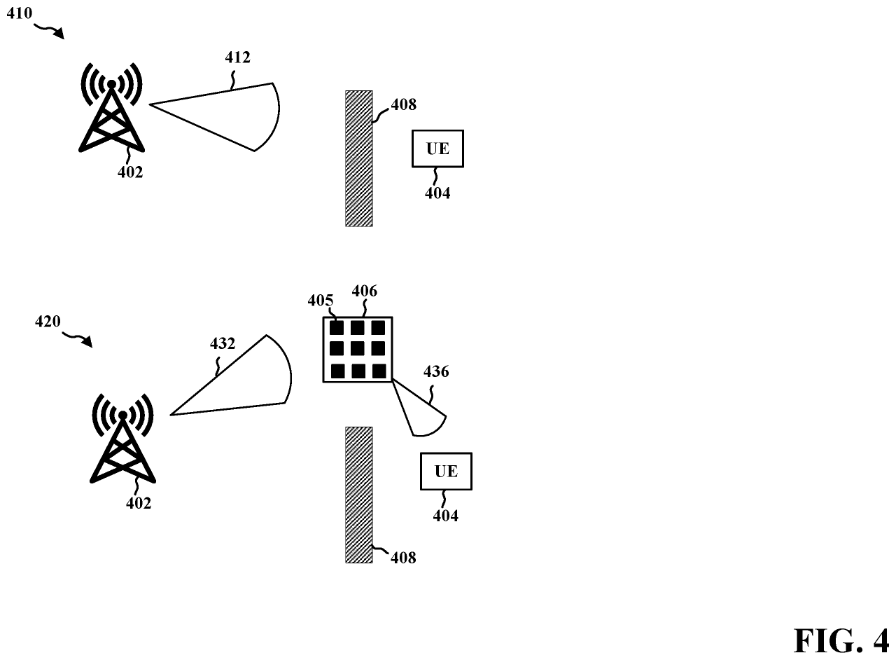

FIG. 4 is a set of diagrams 410 and 420 illustrating a communication between a base station 402 and a UE 404 associated with a blockage 408 without, and with, a RIS 406, in accordance with some aspects of the disclosure. In some aspects, the RIS 406 may include a large number of uniformly distributed electrically controllable elements (e.g., element 405 also referred to as a configurable element or a RIS element). Each element 405 may have a reconfigurable electromagnetic characteristic, e.g., a reflection coefficient. Depending on the combination of configured states of each element 405, the RIS 406 may reflect and modify the incident radio waveform in a controlled manner (e.g., by changing a reflected direction, changing a beam width, etc.). The RIS 406 may function as a near passive device, and the reflection direction may be controlled by the base station. The RIS 406 may reflect an impinging wave in a direction indicated by the base station to a UE.

A RIS (e.g., the RIS 406) may be deployed in wireless communication systems, including cellular systems, such as LTE, NR, etc. An RIS may alter the channel realization in a controlled manner, which may improve channel diversity. The increased diversity may provide robustness to channel blocking/fading, which may be of particular importance for mmWave communication. Compared to a wireless relay or repeater systems, an RIS may be more cost and energy efficient.

As illustrated in FIG. 4, a base station 402 may control the RIS 406 to extend beam coverage and/or to address blockages (e.g., blockage 408) between the base station 402 and the UE 404. Diagram 410 illustrates a blockage 408 that blocks the beam 412 from reception at the UE 404. As illustrated in diagram 420, the base station 402 may transmit communication for the UE 404 using a directional beam 432 (which may be referred to as the impinging beam) to the RIS 406 for reflection over a directional beam 436 to the UE 404. The base station 402 may indicate the directional beam 436 to the RIS 406, and the RIS 406 may reflect the impinging wave associated with directional beam 432 in the direction of the directional beam 436. The RIS 406 may adjust the reflection of the impinging directional beam 432 based on a set of coefficients (e.g., a phase matrix), Φ, indicating a set of configured states (or phases) of the configurable elements (e.g., a state/phase for each element 405) of the RIS 406.

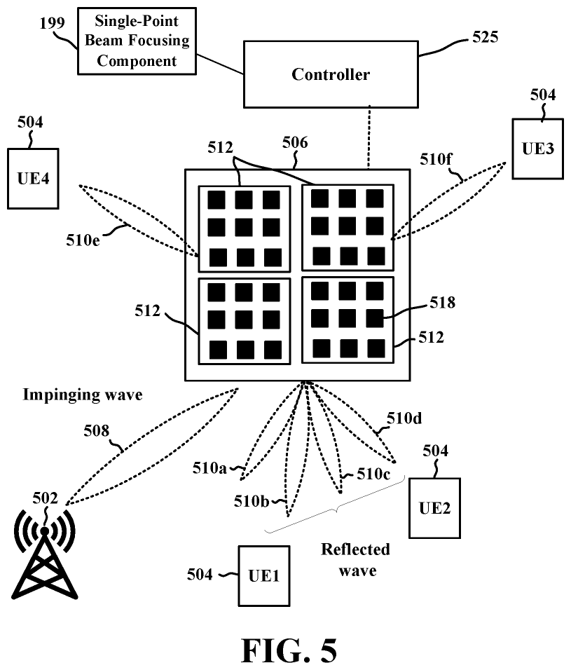

FIG. 5 illustrates an example in which the RIS 506 includes multiple subsets 512 of multiple RIS elements 518. As illustrated, different subsets 512 of RIS elements 518 may serve different UEs 504. Accordingly, the different subsets 512 of multiple RIS elements 518 may be configured differently to adjust the reflected direction, the beam width, or other characteristics of the impinging wave 508, and in some aspects, may each be considered as a separate/independent RIS. The RIS elements 518 may be controlled by a controller 525 (including a single-point beam focusing component 199 as illustrated in FIG. 1) at the RIS 506 based on control information received by the base station 502. As described in connection with FIG. 4, the base station 502 may indicate a beam direction (e.g., any of beam direction 510a, beam direction 510b, beam direction 510c, beam direction 510d, beam direction 510e, or beam direction 510f) to the RIS for reflecting beamformed communication received as the impinging wave 508 to a particular UE 504 in a particular direction. The RIS may similarly be controlled by a UE for reflecting communication from the UE to a base station and/or to another UE.

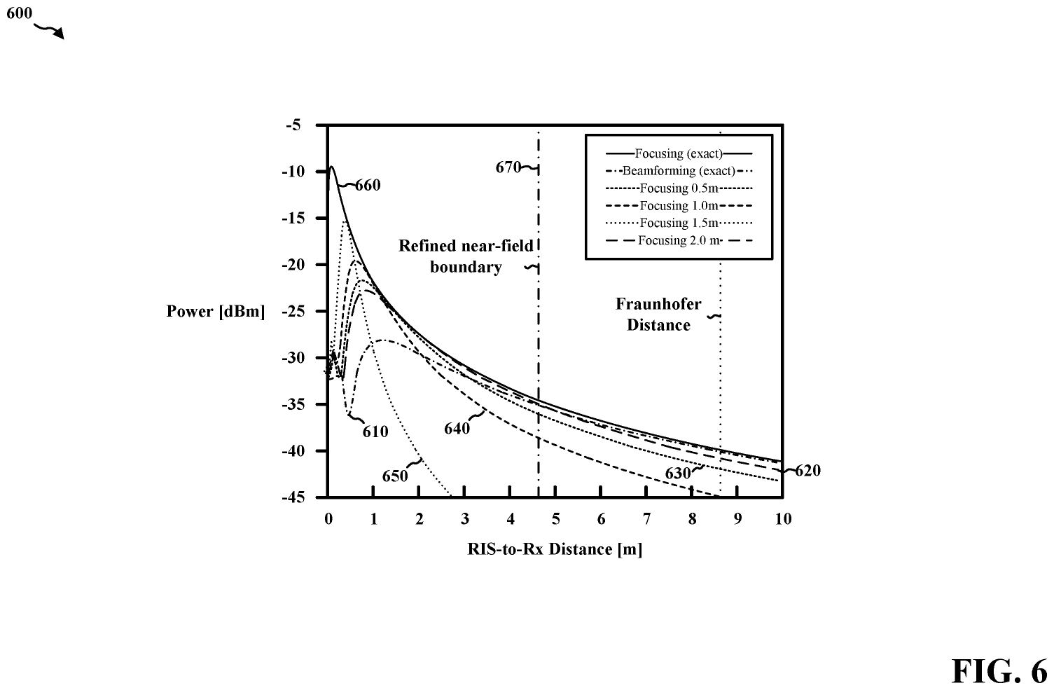

FIG. 6 is a diagram 600 illustrating an example set of power vs. distance curves for different RIS configurations in accordance with some aspects of the disclosure. Diagram 600 may be associated with a base station at a distance of 10 m from a RIS having a 40 by 40 array of configurable reflective elements (e.g., a 40×40 RIS) with λ/2-element-spacing (e.g., for λ=1 cm or a carrier frequency of ˜28 GHZ) and for an incident and reflected beam azimuthal and elevation angles of (45°, 180°) and (36°, 36°), respectively. Diagram 600 illustrates a set of power vs. distance curves (e.g., referred to as power curves in the discussions below) for four different beam focusing configurations associated with different focusing distances, e.g., power curve 620 for a focusing distance of 2 m, power curve 630 for a focusing distance of 1.5 m, power curve 640 for a focusing distance of 1 m, and power curve 650 for a focusing distance of 0.5 m. Diagram 600 also illustrates a power curve 610 associated with a beamforming configuration and a (maximum-achievable) power curve 660 indicating the maximum power achievable at a given distance using a beam focusing configuration (each point on the power curve 660 being achievable by using a different focusing distance for a beam focusing configuration such that no individual beam focusing configuration may match the power curve 660).

As illustrated, for the particular configuration, the received power associated with a beam focusing configuration with a focusing distance of 2 m (e.g., power curve 620) may be superior to beamforming for the (near-field) region from the RIS to a distance identified as a refined near-field boundary 670 (e.g., d_{NF}=4.8 m in the example in FIG. 6). In some aspects, the near-field boundary may depend on one or more of a number of reflective elements associated with the configurable array of reflective elements, an area of each reflective element associated with the configurable array of reflective elements, a wavelength associated with the communication, a first elevation angle associated with an incident transmission, and a second elevation angle associated with a reflected incident transmission. For example, a near-field boundary distance, d_{NF}, may be determined numerically (e.g., calculated) based on an equation such as

$$\frac{{d}_{Tx} {d}_{NF}}{{d}_{Tx} + {d}_{NF}} = \frac{N {d}_{x} {d}_{y}}{λ} \sqrt{cos ( {θ}^{t} ) cos ( {θ}^{r} )} ,$$

where d_{Tx} is a transmitter (e.g., base station) to RIS distance, N is the number of RIS elements (e.g., configurable reflective elements) in the array used for beam focusing/beamforming, dₓ is a size of an individual element of the RIS in a first direction, d_{y} is the size of an individual element of the RIS in a second, perpendicular direction (and dₓd_{y} is an area of the individual element), θ^{t} is an incident elevation angle, θ^{r} is a reflected elevation angle, and λ is a wavelength associated with a frequency associated with the beam focusing/beamforming (e.g., a carrier frequency for wireless communication).

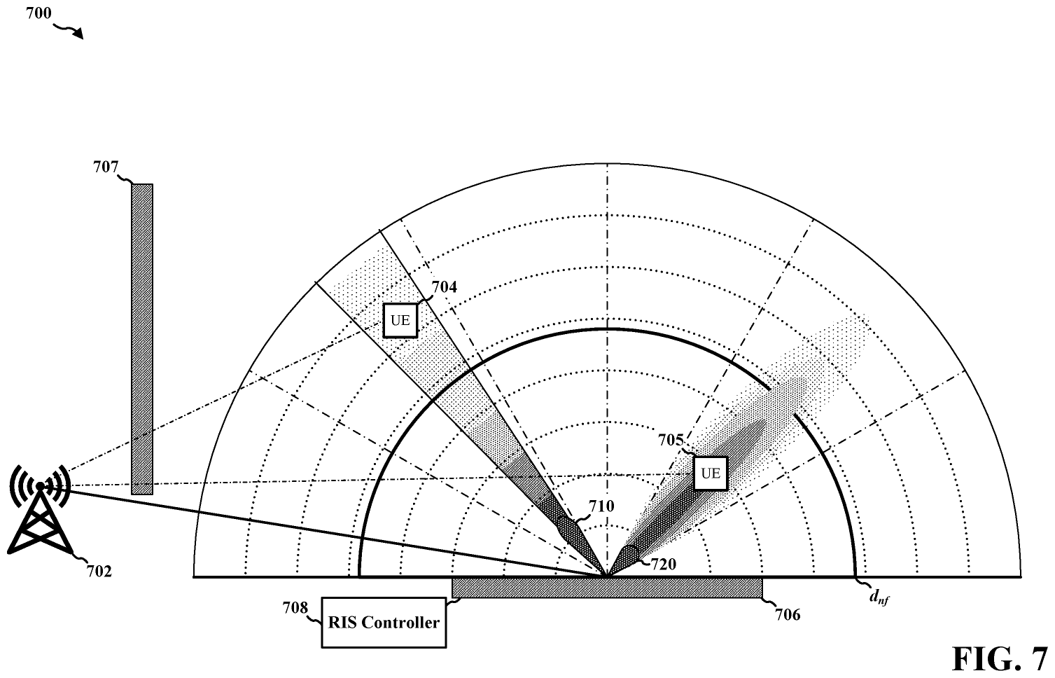

FIG. 7 is a diagram 700 illustrating a base station or RIS controller adjusting a RIS configuration based on a UE being within, or farther than, the near-field boundary distance in accordance with some aspects of the disclosure. The network illustrated in diagram 700, in some aspects, may include a base station 702 for which a line of sight (LoS) to at least a first UE 704 and a second UE 705 is blocked by a blockage 707. Accordingly, the base station 702 may use the RIS to serve the UEs 704 and 705. For example, the base station 702 or the RIS controller 708 may use a particular beam focusing configuration with a single focusing distance (e.g., 1 m, 1.5 m, 2 m, among other examples) for UEs in a near-field region (e.g., within a threshold distance such as ˜2 m, ˜3.1 m, or ˜4.8 m, among other examples). The example in FIG. 6 is merely one example to illustrate the concept, and the near field boundary and single focusing distance may be calculated differently (e.g., based on different equations and associated with different factors than those described above) for different communication systems. In some aspects, the single focusing distance may be selected based on knowledge of the location of one or more UEs served by the base station via the RIS (e.g., the single focusing distance may be selected to optimize a received power for the one or more UEs based on the known locations). As described in connection with FIG. 6, the beam focusing may improve system performs more than a beamforming configuration for UEs within the threshold distance. In some aspects, the base station 702 or RIS controller 708 may use the calculated near-field boundary to determine the single focusing distance to use for a beam focusing 720 from the RIS 706 for serving the second UE 705 within (or closer than) the calculated near-field boundary. Thus, the UEs in the near-field are served with an improved received power (e.g., a gain of over 5 dBm at some distances) through beam focusing 720 with the single focusing distance (e.g., 2 m) that may be determined experimentally or numerically beforehand. In the example described in connection with FIG. 6, for example, the single focusing distance may be 2 m for a near-field boundary of 4.8 m. For serving the first UE 704 that is beyond (or farther than) the near-field boundary, the base station 702 or RIS controller 708 may switch to beamforming 710 to transmit a communication to the UE. Beamforming may be simpler and may have similar performance for UEs beyond the near-field boundary.

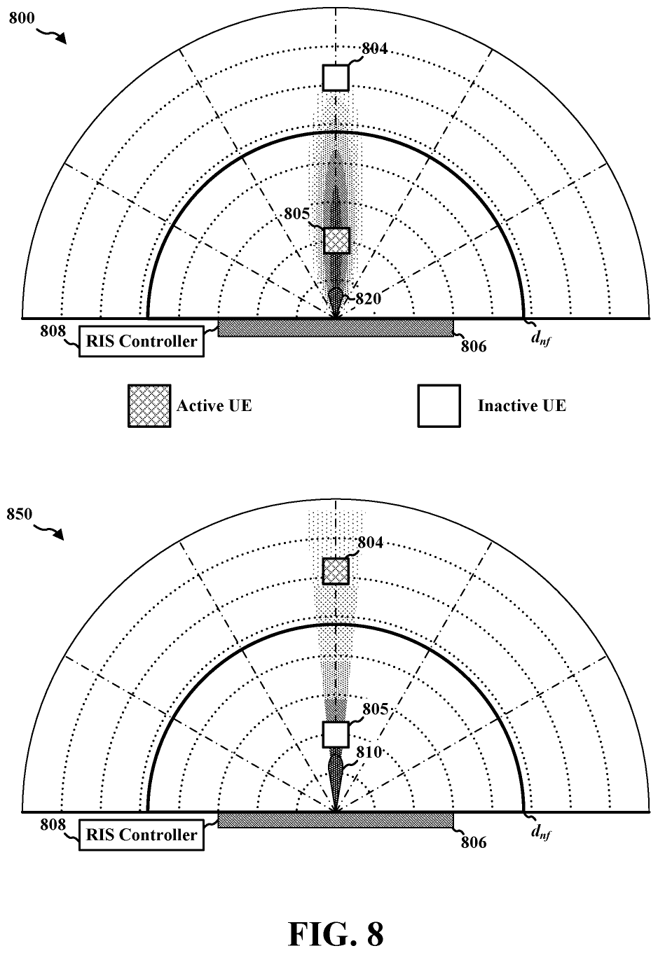

FIG. 8 is a set of diagrams 800 and 850 illustrating two UEs in a same angular region being served at two different times with two different configurations in accordance with some aspects of the disclosure. Referring to FIG. 7, while shown in the same diagram, in some aspects, the beam focusing 720 and the beamforming 710 may be associated with different RIS configurations that may not be capable of being implemented at a same time. Accordingly, diagram 800 illustrates that for a UE 805 within the near-field region, a base station, or RIS controller 808, may serve the UE 805 using a first beam focusing 820. At a different (e.g., subsequent or previous) time, the base station, or the RIS controller 808, may serve the UE 804 in a far-field (e.g., beyond the near-field boundary, d_{NF}, from the RIS 806) using a beamforming 810. The use of the two different RIS configurations, in some aspects, may involves some waste of resources (e.g., in time) associated with switching between the two configurations even when serving UEs in a same angular region as depicted in diagrams 800 and 850.

As discussed in connection with FIGS. 6-8, beam focusing and beamforming may be used for UEs at different distances from the RIS, because beam focusing may outperform beamforming in the near field (i.e., for any distance d such that d≤d_{NF}), whereas beamforming may perform similar to beam focusing in the far field (i.e., d>d_{NF}). Accordingly, complexity associated with beam focusing (e.g., finding the best distance to focus) may be avoided for transmissions to UEs in the far-field by using beamforming instead of beam focusing, As illustrated in FIGS. 7 and 8, this may lead to a particular direction (e.g., angular region) to be served over RIS-assisted links in two distance rings (i.e., one for short-range beam focusing, and other for mid-to-long-range beamforming).

In some aspects, for codebook-based beam alignment, a network node such as a base station may configure the RIS with a phase matrix (e.g., a phase matrix indicating a set of phases associated with the reflective elements of the RIS for the beam focusing or the beamforming configuration) to generate beams that sweep the intended angular region for a given range of UE distance. To this end, the RIS phase matrix may be associated with (1) beam focusing (e.g., including directional beamforming and additional focusing of a directional beam) if the distance of the UE from the RIS is determined to be at most the near-field boundary distance or (2) beamforming (e.g., directional beamforming without additional focusing) if the distance of the UE from the RIS is at least the near-field boundary distance. The base station, in some aspects, may select a focusing distance for beam focusing, which may depend on the RIS attributes (aperture size, element size, number of elements, element spacing, etc.), network configuration (e.g., transmitter/base station-to-RIS distance), and communication setting (e.g., frequency).

For example, in some aspects, a RIS controller (e.g., RIS controller 708 or 808) may inform a base station (e.g., base station 702) of the attributes of an associated RIS (e.g., RIS 706 or 806) (possibly during initial handshaking) to enable the base station to determine, identify, or select, a distance (e.g., an optimal or calculated focusing distance based on a near-field boundary distance associated with the RIS characteristics or attributes) to focus as well as the beam-steering angles and/or directions. In some aspects, the base station may provide, or transmit, angular direction (or a set of directions) to the RIS controller, which may compute, determine, or identify (e.g., may select from a set of precomputed values) a focusing distance based on knowledge of the RIS characteristics or attributes.

For an angle and distance region that spans over both the near and far fields, the base station, in some aspects, may configure the RIS with a first phase matrix associated with beam focusing for the near-field and with a second phase matric associated with beamforming for the far-field. Accordingly, the base station may then cover (e.g., serve) the whole desired region with only two distance rings, where regular beam focusing would normally be associated with more focusing distances, or distance rings, and a larger set of corresponding RIS configurations and hence would increase the beam signaling overhead (e.g., the overhead associated with implementing the larger set of RIS configurations). For example, in some aspects, a full beam focusing implementation may be associated with a different focusing distance (and phase matrix) for each UE served by the base station and control signals may be exchanged to reconfigure a RIS configuration before each communication with a different UE. In some aspects, the base station may configure the RIS to use a smaller number of reflecting elements to change the near-field boundary (e.g., to make the near-field region small in order to serve the UEs primarily with beamforming, or vice versa). The aspects discussed above using two RIS configurations, in some aspects, may represent a first mode of operation (e.g., a dual-RIS-configuration mode of operation) that a base station may select.

Additionally, or alternatively, a base station or a RIS may operate in a second mode in which all the UEs, e.g., at any distance, are served with a beam focusing with a single focusing distance. In contrast to the description of FIGS. 6-8 above, a single phase matrix associated with beam focusing may be used, e.g., even for UEs beyond the near-field boundary, to eliminate the added overhead and/or complexity associated with using different beam techniques to serve UEs based on different distances (e.g., associated with switching between beam focusing and beamforming). Avoiding the use of two distance rings or ranges (and hence two separate RIS phase matrices) for each direction (or angular region) may lead to reduced received power in very short distances (regions of near field sufficiently close to the RIS) compared to a beam focusing configuration with a different focusing distance. In some aspects, the reduction may be associated with selecting a focusing distance that is longer, or larger, to maintain an acceptable power in the far field. However, as the received power in the close-distance regime (e.g., a near-field or very-near-field) is higher, the reduction in the received power may be acceptable.

As an example, for a base station at a distance of 100 m from a RIS having a 100 by 100 array of configurable reflective elements (e.g., a 100×100 RIS) with λ/2-element-spacing (e.g., for λ=1 cm or a carrier frequency of ˜28 GHZ) beam focusing with a particular focusing distance may be almost as good as beamforming in the far-field and better than beamforming in the near-field. As discussed above, different beam focusing configurations associated with different/focusing distances, e.g., for a focusing distance of 10 m and 20 m, may be associated with different received powers in the near-field. For example, if beam focusing is used to transmit to UEs without considering distance from the RIS, the use of a single beam focusing phase matrix with a single focus distance, e.g., 20 m, may have a reduction in received of 2.5 dB in the near field, e.g., within 12 m of the RIS, when compared to a dual-RIS-configuration mode using a beam focusing phase matrix with a shorter focus distance, e.g., 10 m, within the near field threshold and beamforming outside of the near field.

In some network configurations, e.g., for a base station at a distance of 10 m from the RIS in the last example, the received power for beam focusing with a focusing distance of 20 m may be superior to beamforming over all the distances shown (i.e., both in the near and far fields) with a considerable performance gap. This performance gap may be experienced because the receiver experiences a near-field effect (for various distances of the receiver from the RIS) due to the base station being within a minimum distance from the RIS (e.g., a minimum distance given as

$${d}_{min} = \frac{{Nd}_{x} {d}_{y}}{λ} \sqrt{cos ( {θ}^{t} ) cos ( {θ}^{r} )} ,$$

which may be evaluated as 20.25 m for the 100×100 RIS, or as 3.24 m for a 40×40 RIS with other factors constant (e.g., λ/2-element-spacing (e.g., for 1=1 cm or a carrier frequency of ˜28 GHZ) and for an incident and reflected beam azimuthal and elevation angles of (45°, 180°) and (36°, 36°), respectively). Accordingly, the beamforming does not perform close to beam focusing in this near-field setting. Accordingly, after ˜20 m the beam focusing with a single focusing distance of 20 m (i.e., a single RIS phase matrix) may perform similarly to using a plurality of distance-specific beam focusing (e.g., with a different phase matrix for each distance).

In a single-distance (or single-point) beam focusing, for codebook-based beam alignment, the base station may configure the RIS with a phase matrix (e.g., a phase matrix indicating a set of phases associated with the reflective elements of the RIS for the beam focusing or the beamforming configuration) to generate beams that sweep the desired angular region for all UE distances. To this end, the RIS phase matrix may be associated with a single-point beam focusing (e.g., including directional beamforming and additional focusing of a directional beam). The base station, in some aspects, may select a focusing distance for beam focusing, which may depend on the RIS attributes (aperture size, element size, number of elements, element spacing, etc.), network configuration (e.g., transmitter/base station-to-RIS distance), and communication setting (e.g., frequency).

For example, in some aspects, a RIS controller (e.g., RIS controller 708 or 808) may inform a base station (e.g., base station 702) of the attributes of an associated RIS (e.g., RIS 706 or 806) (possibly during initial handshaking) to enable the base station to determine, identify, or select, a distance (e.g., an optimal or calculated focusing distance associated with the RIS characteristics or attributes) to focus as well as the beam-steering angles and/or directions. In some aspects, the base station may provide, or transmit, angular direction (or a set of directions) to the RIS controller, which may compute, determine, or identify (e.g., select from a set of precomputed values) a focusing distance based on knowledge of the RIS characteristics or attributes).

For an angle and distance region that spans over both the near and far fields, the base station, in some aspects, may configure the RIS with a first phase matrix associated with beam focusing for both the near-field and the far-field. Accordingly, the base station may then cover (e.g., serve) the region with a single distance ring, where regular beam focusing may otherwise be associated with more distances, or distance rings, that could increase the beam signaling overhead.

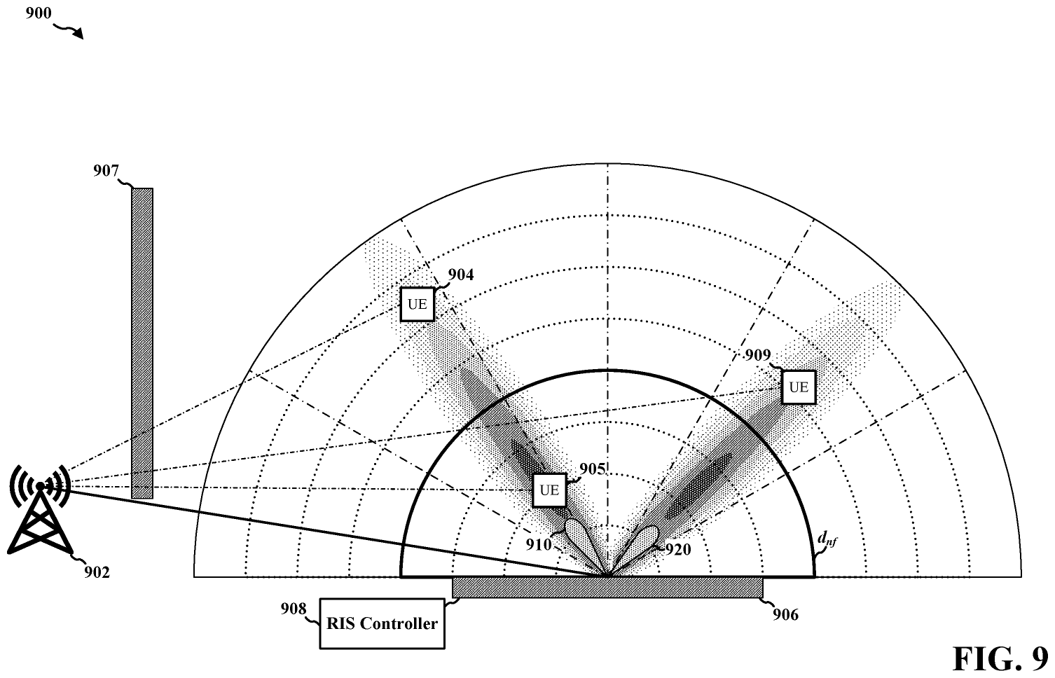

FIG. 9 is a diagram 900 illustrating a base station or RIS controller using a single-distance beam focusing RIS configuration for UEs that are at multiple distances from the RIS including within a near-field boundary distance, d_{NF}, and beyond the near-field boundary distance in accordance with some aspects of the disclosure. The network illustrated in diagram 900, in some aspects, may include a base station 902 for which a LoS to at least a first UE 904, a second UE 905, and a third UE 909 is blocked by a blockage 907. For example, the base station 902 or the RIS controller 908 may determine to use a particular beam focusing configuration with a single focusing distance (e.g., 20 m) for UEs at all distances from the RIS 906 (e.g., a focusing distance that is independent of the distance between the RIS and any particular UE).

A first beam focusing 910 in a first direction, in some aspects, may be used to serve the first UE 904 and the second UE 905 in a first angular region and a second beam focusing 920 (using the same focusing distance as the beam focusing 910) may be used to serve the third UE 909. In some aspects, the beam focusing 910 and the beam focusing 920 may not be capable of being implemented at a same time, as RIS configurations (e.g., phase matrices) associated with different beam focusing operations may be different based on the different beam directionality/steering even if the focusing distance is the same. Accordingly, a base station 902, or RIS controller 908, may serve the first UE 904 and/or the second UE 905 during a first time period associated with a first RIS configuration (e.g., based on a first phase matrix) using the first beam focusing 910. At a different (e.g., subsequent or previous) time, the base station, or the RIS controller 908, may serve the third UE 909 using a beam focusing 920 (e.g., using a second RIS configuration associated with a second phase matrix). The use of the single-distance beam focusing (e.g., a single RIS configuration) in each angular region may, in some aspects, involve less waste of resources (e.g., in time) by avoiding resource waste associated with switching between the two configurations that occurs even when serving UEs in a same angular region in a dual-RIS-configuration mode of operation as depicted in FIGS. 7 and 8.

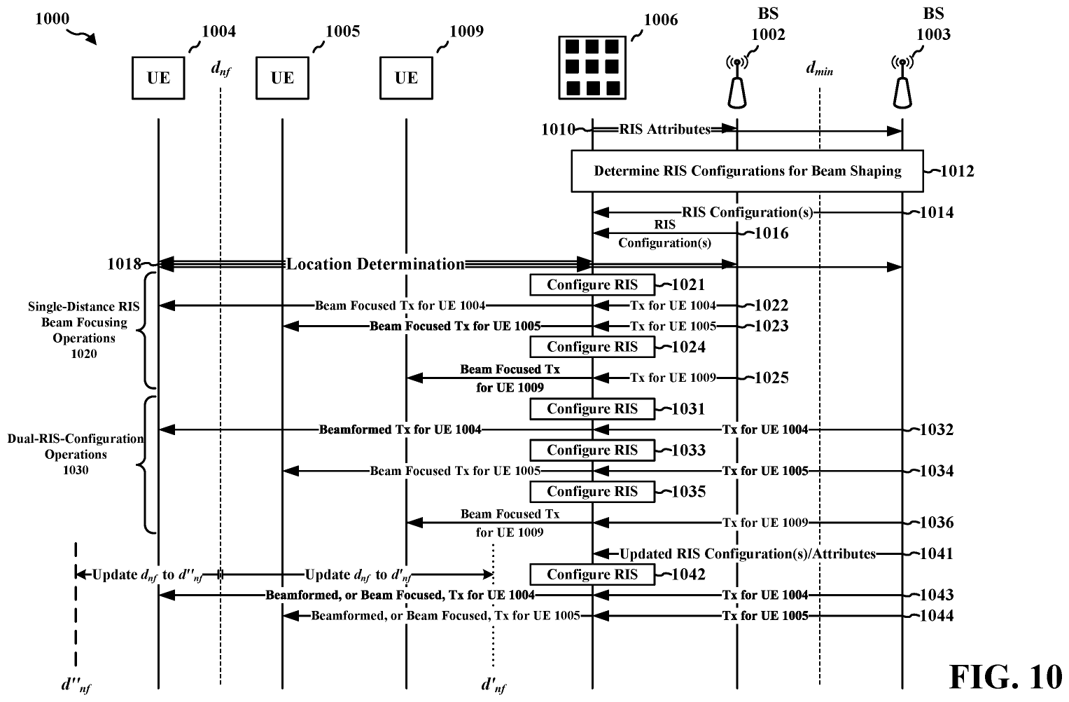

FIG. 10 is a call flow diagram 1000 illustrating aspects of the disclosure. Call flow diagram 1000 illustrates a RIS 1006 (e.g., a network device including a RIS and a RIS controller) that may be associated with two base stations, e.g., a first base station 1002 and a second base station 1003. The first base station 1002, in some aspects, may be within a threshold distance (e.g., dₘᵢₙ) of the RIS 1006 associated with better performance of a single-distance beam focusing compared to a beamforming for all relevant distances. The second base station 1003, in some aspects, may be beyond the threshold distance from the RIS such that each of beamforming and a single-distance beam focusing perform better at some distances (and worse at others) when compared to each other. Before beginning to use the RIS 1006, the RIS 1006 may transmit, and the base stations 1002 and 1003 may receive an indication 1010 of a set of RIS attributes (e.g., an aperture size, an element size, a number of elements, an element spacing, etc.) that affects the optimum beam focusing distance for a beam focusing configuration in both, or either, of a single-distance beam focusing mode of operation or a dual-RIS-configuration mode of operation and may affect a near-field boundary distance associated with a dual-RIS-configuration mode of operation.

At 1012, one or more of the first base station 1002, the second base station 1003, or the RIS 1006, may determine a mode of operation (e.g., single-distance beam focusing or dual-RIS-configuration) and one or more associated RIS configurations for beam shaping (e.g., either beam focusing or beamforming) communications between a base station and one or more UEs, e.g., UE 1004, UE 1005, and UE 1009, based on the RIS attributes included in the indication 1010. The determination, in some aspects, may be made as discussed above in relation to FIGS. 6-9, and (if the determination at 1012 is made at the base stations 1002 and 1003) the base stations 1002 and 1003 may transmit, and RIS 1006 may receive, a set of RIS configurations 1014 and a set of RIS configurations 1016, respectively (e.g., a set of one or more phase matrices for different beam focusing or beamforming configurations). In some aspects, the set of RIS configurations 1014 and 1016 may include at least one RIS configuration for each of a set of angular regions around the RIS 1006 and may include a beam focusing and/or a beamforming RIS configuration for each angular region. The set of RIS configurations 1014 and 1016, in some aspects, may be transmitted via RRC signaling or layer 1 or layer 2 signaling (e.g., via DCI, or a MAC control element (MAC-CE)).

In some aspects, before engaging in communication with a particular UE of the UEs 1004, 1005, and 1009, the base stations 1002 and 1003, or the RIS 1006 may exchange location determination signals 1018 (e.g., position reference signals for determining a location/position including an associated angle and distance, or beam swept reference signals for determining an associated angle or angular position without acquiring distance information). After acquiring location information sufficient for a selected mode of operation, communication may be initiated.

For example, in some aspects, the first base station 1002 may serve the UEs 1004, 1005, and 1009 via a RIS using a set of single-distance RIS beam focusing operations 1020. As discussed in connection with FIGS. 4 and 5, the RIS may receive communication from the base station at an incident angle and may reflect the communication to the UE at a different angle. At 1021, the RIS 1006 may be configured based on the set of RIS configurations 1016. For example, the first base station 1002 may select a single-distance beam focusing RIS configuration for serving all the UEs based on the transmitter-RIS distance being below the threshold distance (e.g., dₘᵢₙ) such that beam focusing is better for all relevant distances. Accordingly, the configuration at 1021 may configure a single-focus beam focusing in a particular direction associated with UE 1004 and 1005 (corresponding to the first UE 904 and the second UE 905 of FIG. 9). Based on the configuration at 1021, the first base station 1002 may transmit, RIS 1006 may beam focus, and the UEs 1004 and 1005 may receive, a transmission 1022 and 1023 (or associated beam focused transmissions), respectively. In order to communicate with the UE 1009 in another angular region, the RIS 1006 may, at 1024, be configured based on a configuration for the angular region associated with UE 1009, e.g., indicated in the set of RIS configurations 1016. Based on the configuration at 1024, the second base station 1003 may transmit, RIS 1006 may beam focus, and the UE 1009 may receive, a transmission 1025 (or an associated beam focused transmission). By operating in the single-distance RIS beam focusing mode of operation, the first base station 1002 may save resources associated with switching a RIS configuration between the transmissions 1022 and 1023 (e.g., signaling resources associated with indicating for the RIS to perform a reconfiguration, or “gap” resources that are not able to be used during a transition between RIS configurations).

In some aspects, the second base station 1003 may serve the UEs 1004, 1005, and 1009 using a set of dual-RIS configuration operations 1030. At 1031, the RIS 1006 may be configured based on the set of RIS configurations 1014. For example, referring to FIGS. 6-8, the second base station 1003 may select a first beam focusing RIS configuration (with a particular focusing distance) for serving the UEs within the near-field boundary (e.g., d_{NF}) and a second beamforming for serving the UEs beyond the near-field boundary based on the transmitter-RIS distance being greater than the threshold distance (e.g., dₘᵢₙ) such that beam focusing is better up to the near-field boundary and the beamforming is better beyond the near-field boundary. Accordingly, for a first communication with the UE 1004 beyond the near-field boundary, the configuration at 1031 may configure a beamforming in a particular direction associated with UE 1004. Based on the configuration, the second base station 1003 may transmit, RIS 1006 may beamform, and the UE 1004 may receive, a transmission 1032 (or an associated beamformed transmission). In order to communicate with the UE 1005 in a same angular region, but within the near-field boundary, the RIS 1006 may, at 1033, be configured based on a beam focusing configuration for the angular region associated with UE 1005, e.g., a beam focusing configuration indicated in the set of RIS configurations 1016. Based on the configuration at 1033, the second base station 1003 may transmit, RIS 1006 may beam focus, and the UE 1005 may receive, a transmission 1034 (or an associated beam focused transmission). Similarly, in order to communicate with the UE 1009 within the near-field boundary, but in another angular region, the RIS 1006 may, at 1035, be configured based on a beam focusing configuration for the angular region associated with UE 1009, e.g., indicated in the set of RIS configurations 1016. Based on the configuration at 1035, the second base station 1003 may transmit, RIS 1006 may beam focus, and the UE 1009 may receive, a transmission 1036 (or an associated beam focused transmission). By operating in the dual-RIS-configuration mode of operation, the second base station 1003 may improve a received power for UEs within the near-field boundary and avoid complexity and overhead associated with determining, for each UE served, a distance for a beam focusing configuration and switching between beam focusing configurations for every different UE. For example, by scheduling transmissions for a plurality of UEs in a same angular region within the near-field boundary, the base station may transmit to the plurality of UEs in a set of consecutive resources without introducing a gap to update a RIS configuration.

In some aspects, in order to serve more UEs (e.g., UEs in a same angular region, but at different distances from the RIS) using a same beamforming, or beam focusing, configuration, a base station, e.g., the second base station 1003, may transmit a request or indication 1041 to update a RIS configuration, e.g., a number of elements to use for the beamforming and/or beam focusing configurations, or indicating RIS configurations specifying a state for, or a phase matrix associated with, a different number of RIS elements than currently used for beam focusing or beamforming. For example, the indication 1041 may be associated with a smaller (or larger) number of RIS elements such that the near-field boundary, d′NF (or d′NF), calculated for the smaller (or larger) number of RIS elements may be smaller (or larger), thus making it more likely that a given UE will be associated with a beamforming (or beam focusing) configuration and transitions between beamforming and beam focusing (or vice versa) may be less common and may accordingly waste fewer resources associated with transitions between RIS configurations. For example, based on the indication 1041, the RIS 1006 may be configured at 1042 for one of a beamforming or beam focusing configuration in a particular direction associated with UE 1004 and 1005. Based on the configuration at 1042, the second base station 1003 may transmit, RIS 1006 may beam focus or beamform, and the UEs 1004 and 1005 may receive, transmissions 1043 and 1044 (or associated beam focused or beamformed transmissions), respectively. Accordingly, the second base station 1003 may avoid wasted resources associated with switching between a beamforming and a beam focusing configuration for UEs in a same angular region (e.g., UEs not already associated with a change in configuration based on a change in the reflected angle of the beamformed, or beam focused, transmission). However, this may be achieved at the cost of reduced received power in the near-field (or the far-field).

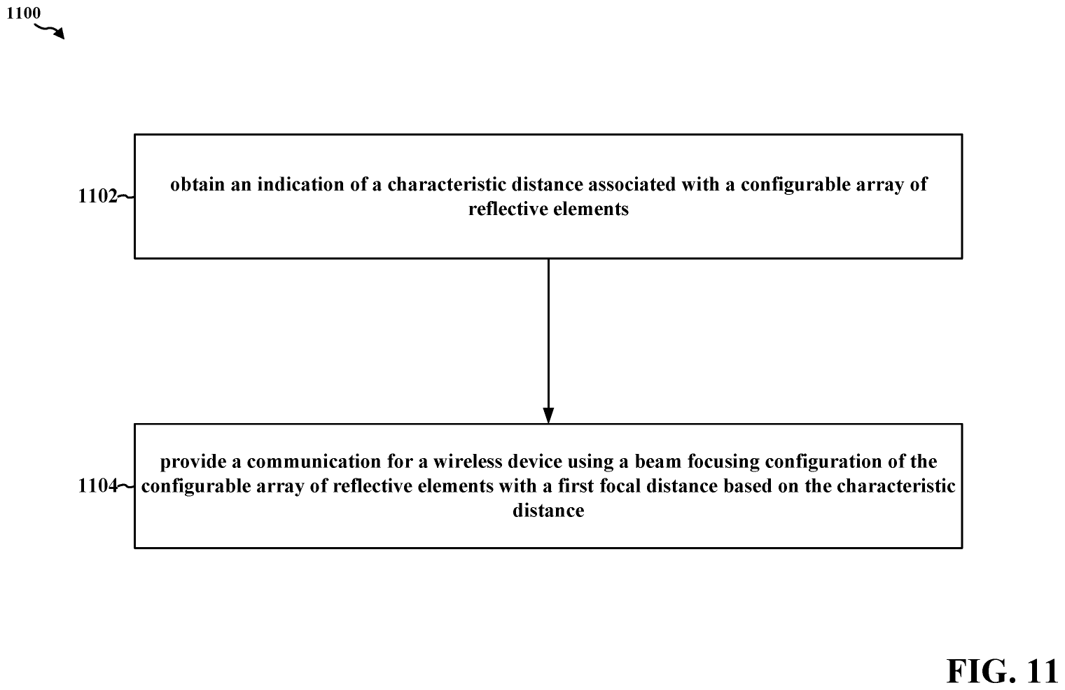

FIG. 11 is a flowchart 1100 of a method of wireless communication. The method may be performed by a network device that may be one of a base station, a RIS (e.g., a configurable array of reflective elements), a RIS controller, or a device including a RIS controller and a RIS (e.g., the base station 102, 702, 902, 1002, 1003; the RIS 103, 706, 806, 906, 1006, or 1740; the RIS controller 108, 708, or 908; the controller 1741; the network entity 1602). In some aspects, a RIS controller may obtain, or a RIS may provide to the network device (e.g., the base station or the RIS controller), a first set of attributes of the RIS. The first set of attributes, in some aspects, may include one or more of an aperture size of the configurable array of reflective elements, a reflective element size (or area), a number of reflective elements, or an inter-element spacing of the configurable array of reflective elements.

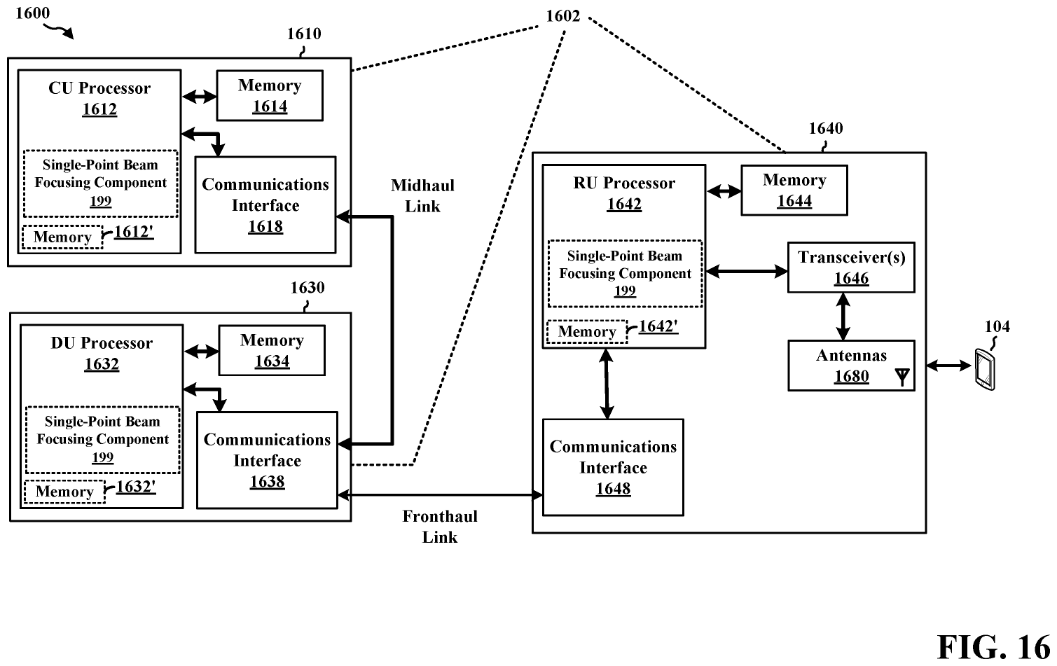

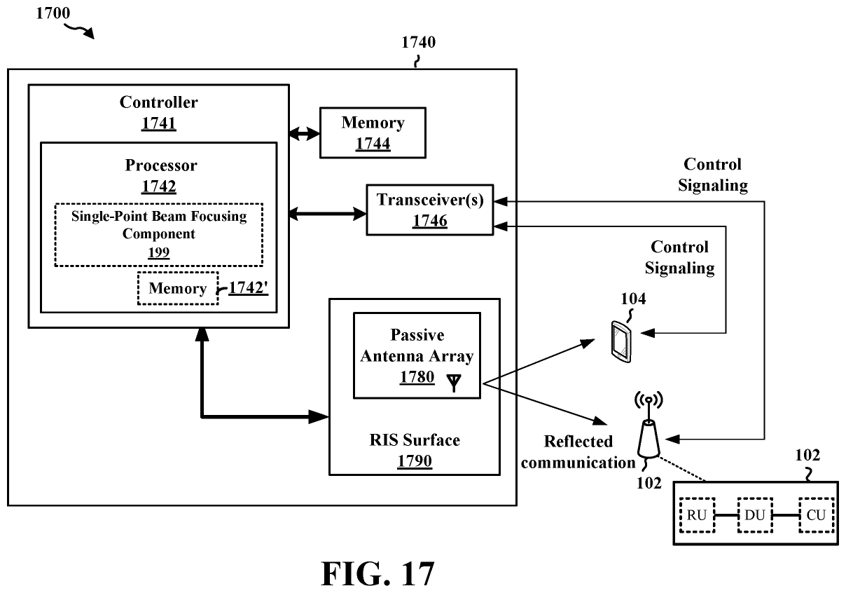

At 1102, the network device may obtain an indication of a characteristic distance associated with a configurable array of reflective elements. For example, 1302 may be performed by CU processor 1612, DU processor 1632, RU processor 1642, transceiver(s) 1646, antenna(s) 1680, controller 1741, processor 1742, transceiver(s) 1746, and/or single-point beam focusing component 199 of FIGS. 16 and 17. The characteristic distance, in some aspects, may be one of a first focusing distance used for a beam focusing at the RIS or a near-field boundary distance associated with the first focusing distance. In some aspects, when the network device is a RIS, obtaining the indication of the characteristic distance may include receiving, from a second network device (e.g., the base station), configuration information (e.g., a first phase matrix) for the beam focusing configuration with the first focusing distance based on providing the first set of attributes to the second network device or determining, at the RIS, the characteristic distance based on a first set of attributes of the configurable array of reflective elements and a second set of attributes of the communication. When the network device is a base station, obtaining the indication of the characteristic distance may include receiving the first set of attributes from a RIS or RIS controller and determining the characteristic distance based on the first set of attributes and a second set of attributes of the communication. For example, referring to FIG. 10, the RIS 1006 may transmit, and the base stations 1002 and 1003 may receive an indication 1010 of a set of RIS attributes (e.g., an aperture size, an element size, a number of elements, an element spacing, etc.) that affects the optimum beam focusing distance (e.g., a characteristic distance associated with the RIS) for a beam focusing configuration in both, or either, of a single-distance beam focusing mode of operation or a dual-RIS-configuration mode of operation and may affect a near-field boundary distance (e.g., an additional characteristic distance) associated with a dual-RIS-configuration mode of operation.

At 1104, the network device may provide a communication for a wireless device using a beam focusing configuration of the configurable array of reflective elements with a first focusing distance based on the characteristic distance. For example, 1302 may be performed by CU processor 1612, DU processor 1632, RU processor 1642, transceiver(s) 1646, antenna(s) 1680, controller 1741, processor 1742, transceiver(s) 1746, passive antenna array 1780, RIS surface 1790, and/or single-point beam focusing component 199 of FIGS. 16 and 17. In some aspects, providing the communication using the beam focusing configuration of the configurable array of reflective elements with the first focusing distance is based on a first distance between the wireless device and the configurable array of reflective elements being less than a threshold distance. If the network device is a base station, providing the first communication may include transmitting the first communication to a RIS for reflection to the first UE based on the beam focusing configuration. If the network device is the RIS, providing the first communication may include reflecting the first communication from a base station to a UE for reflection to the first UE based on the beam focusing configuration that may include directional beamforming and additional focusing of a directional beam. For example, referring to FIG. 10, the first base station 1002 may transmit transmissions 1022, 1023, or 1025, the second base station 1003 may transmit transmissions 1034, 1036, 1043, or 1044 to be beam focused by RIS 1006 for reflection to provide the transmission to one of UE 1004, 1005, or 1009.

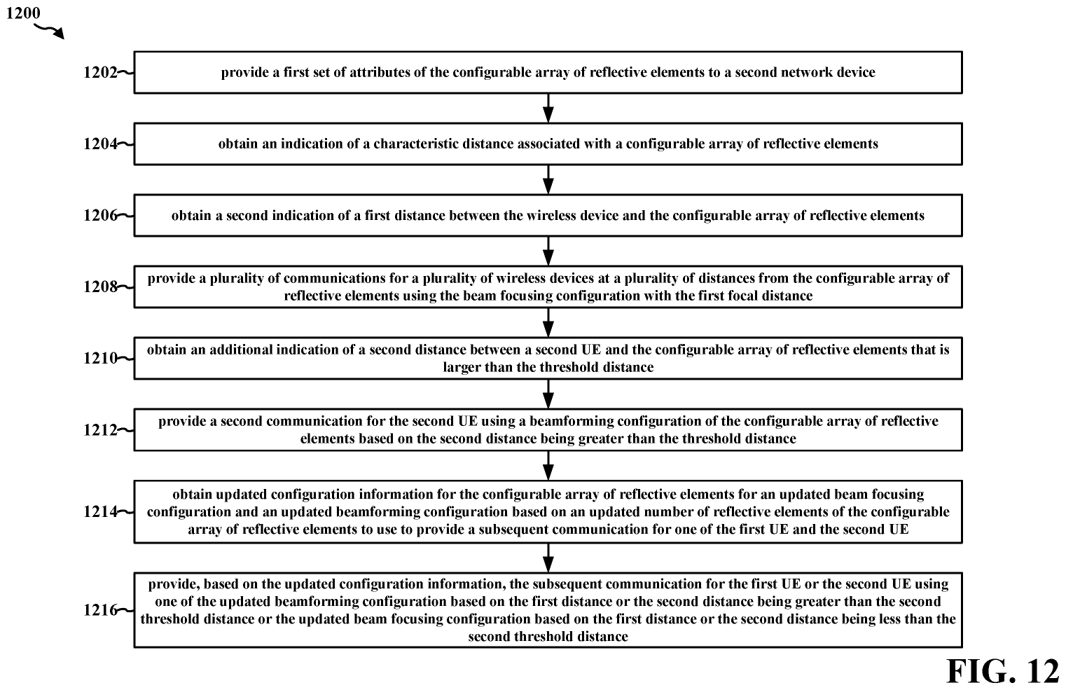

FIG. 12 is a flowchart 1200 of a method of wireless communication. The method may be performed by a network device that may be one of a RIS (e.g., a configurable array of reflective elements), a RIS controller, or a device including a RIS controller and a RIS (e.g., the RIS 103, 706, 806, 906, 1006, or 1740; the RIS controller 108, 708, or 908; the controller 1741; the network entity 1602). For clarity, the network device will be referred to as a RIS for the discussion of FIG. 12. At 1202, the RIS may provide a first set of attributes of the configurable array of reflective elements (e.g., the RIS) to a second network device (e.g., a base station). For example, 1202 may be performed by controller 1741, processor 1742, transceiver(s) 1746, and/or single-point beam focusing component 199 of FIG. 17. The first set of attributes, in some aspects, may include one or more of an aperture size of the configurable array of reflective elements, a reflective element size (or area), a number of reflective elements, or an inter-element spacing of the configurable array of reflective elements. For example, referring to FIG. 10, the RIS 1006 may transmit, and the base stations 1002 and 1003 may receive indication 1010 of a set of RIS attributes (e.g., an aperture size, an element size, a number of elements, an element spacing, etc.) that affects the optimum beam focusing distance (e.g., a characteristic distance associated with the RIS) for a beam focusing configuration in both, or either, of a single-distance beam focusing mode of operation or a dual-RIS-configuration mode of operation and may affect a near-field boundary distance (e.g., an additional characteristic distance) associated with a dual-RIS-configuration mode of operation.

At 1204, the RIS may obtain an indication of a characteristic distance associated with the configurable array of reflective elements (e.g., the RIS). For example, 1204 may be performed by controller 1741, processor 1742, transceiver(s) 1746, and/or single-point beam focusing component 199 of FIG. 17. In some aspects, obtaining the indication of the characteristic distance includes receiving, from the second network device, configuration information for a beam focusing configuration with a first focusing distance based on providing the first set of attributes to the second network device at 1202. In some aspects, obtaining the indication of a characteristic distance may include receiving, from the network node (e.g., a base station), phase-matrix configuration information indicating a first phase matrix associated with a beam focusing configuration and a second phase matrix associated with a beamforming configuration. For example, referring to FIG. 10, the RIS 1006 may receive the set of RIS configurations 1014 and 1016 from the base stations 1002 and 1003, respectively.

In some aspects, obtaining the indication of the characteristic distance associated with the configurable array of reflective elements includes determining, at the RIS, the characteristic distance based on a first set of attributes of the configurable array of reflective elements and a second set of attributes of the communication. In some aspects, the characteristic distance may be based on one or more of a number of reflective elements associated with the configurable array of reflective elements, an area of each reflective element associated with the configurable array of reflective elements, a wavelength associated with the plurality of communications, a first elevation angle associated with an incident transmission, a second elevation angle associated with a reflected incident transmission, and a distance from the configurable array of reflective elements to a transmitter device (e.g., a network device or base station) transmitting a plurality of communications via the configurable array of reflective elements. For example, referring to FIG. 10, the RIS 1006 may, at 1012, determine a mode of operation (e.g., single-distance beam focusing or dual-RIS-configuration) and one or more associated RIS configurations for beam shaping (e.g., either beam focusing or beamforming) communications between a base station and one or more UEs. e.g., UE 1004, UE 1005, and UE 1009, based on the RIS attributes included in the indication 1010.

At 1206, the RIS may obtain a second indication of a first distance between the wireless device and the configurable array of reflective elements. For example, 1206 may be performed by controller 1741, processor 1742, transceiver(s) 1746, and/or single-point beam focusing component 199 of FIG. 17. Referring to FIG. 10, for example, the RIS 1006 may exchange location determination signals 1018 (e.g., position reference signals for determining a location/position including an associated angle and distance, or beam swept reference signals for determining an associated angle or angular position without acquiring distance information) with one or more of the UEs 1004, 1005, or 1009 to acquire location information sufficient for a selected mode of operation. In other examples, the RIS 1006 may receive the information from the first base station 1002 or the second base station 1003 or in another manner.

At 1208, the RIS may provide a plurality of communications for a plurality of wireless devices at a plurality of distances from the configurable array of reflective elements using the beam focusing configuration with the first focusing distance. For example, 1208 may be performed by controller 1741, processor 1742, transceiver(s) 1746, passive antenna array 1780, RIS surface 1790, and/or single-point beam focusing component 199 of FIG. 17. In some aspects, providing the plurality of communications at 1208, may include providing a communication for a wireless device using a beam focusing configuration of the configurable array of reflective elements with a first focusing distance based on the characteristic distance. In some aspects, the first focusing distance may be based on a first set of attributes of the configurable array of reflective elements and a second set of attributes of the communication. The first set of attributes, as discussed above, may include one or more of an aperture size of the configurable array of reflective elements or an inter-element spacing of the configurable array of reflective elements, and the second set of attributes may include a frequency associated with the communication. In some aspects, beam focusing may include directional beamforming and additional focusing of a directional beam. For example, referring to FIG. 10, the first base station 1002 may transmit transmissions 1022, 1023, or 1025, the second base station 1003 may transmit transmissions 1034, 1036, 1043, or 1044 to be beam focused by RIS 1006 to provide the transmission to one of UE 1004, 1005, or 1009.

At 1210, the RIS may obtain an additional indication of a second distance between a second UE and the configurable array of reflective elements that is larger than the threshold distance. For example, 1210 may be performed by controller 1741, processor 1742, transceiver(s) 1746, and/or single-point beam focusing component 199 of FIG. 17. Referring to FIG. 10, for example, the RIS 1006 may exchange location determination signals 1018 (e.g., position reference signals for determining a location/position including an associated angle and distance, or beam swept reference signals for determining an associated angle or angular position without acquiring distance information) with one or more additional UE of the UEs 1004, 1005, or 1009 to acquire location information sufficient for a selected mode of operation.

At 1212, the RIS may provide a second communication for the second UE using a beamforming configuration of the configurable array of reflective elements based on the second distance being greater than the threshold distance. For example, 1212 may be performed by controller 1741, processor 1742, transceiver(s) 1746, passive antenna array 1780, RIS surface 1790, and/or single-point beam focusing component 199 of FIG. 17. In some aspects, the beamforming configuration may be associated with directional beamforming without additional focusing of the directional beam. For example, referring to FIG. 10, the first base station 1002 may transmit transmissions 1022, 1023, or 1025, the second base station 1003 may transmit transmissions 1032, 1043, or 1044 to be beamformed by RIS 1006 to provide the transmission to one of UE 1004, 1005, or 1009.

At 1214, the RIS may obtain updated configuration information for the configurable array of reflective elements for an updated beam focusing configuration and an updated beamforming configuration based on an updated number of reflective elements of the configurable array of reflective elements to use to provide a subsequent communication for one of the first UE and the second UE. For example, 1214 may be performed by controller 1741, processor 1742, transceiver(s) 1746, and/or single-point beam focusing component 199 of FIG. 17. In some aspects, a second threshold distance associated with the updated configuration information may be one of less than the first distance (associated with the first wireless device) or greater than the second distance (associated with the second wireless device) based on the updated number of reflective elements. For example, referring to FIG. 10, the RIS controller may receive a request or indication 1041 to update a RIS configuration, that may be associated with a near-field boundary, d′NF (or d′NF), that is one of less than a first distance to the UE 1009 or greater than a second distance to the UE 1004. At 1216, the RIS may provide, based on the updated configuration information, the subsequent communication for the first UE or the second UE using one of the updated beamforming configuration based on the first distance or the second distance being greater than the second threshold distance or the updated beam focusing configuration based on the first distance or the second distance being less than the second threshold distance. For example, 1216 may be performed by controller 1741, processor 1742, transceiver(s) 1746, passive antenna array 1780, RIS surface 1790, and/or single-point beam focusing component 199 of FIG. 17. Referring to FIG. 10, for example, the RIS 1006 may beam shape both transmissions 1043 and 1043 using one of a beamforming configuration if an updated near-field boundary, d′_{NF}, is smaller than the distance to the UEs 1004 and 1005, or using a beam focusing configuration if an updated near-field boundary, d″_{NF}, is larger than the distance to the UEs 1004 and 1205.

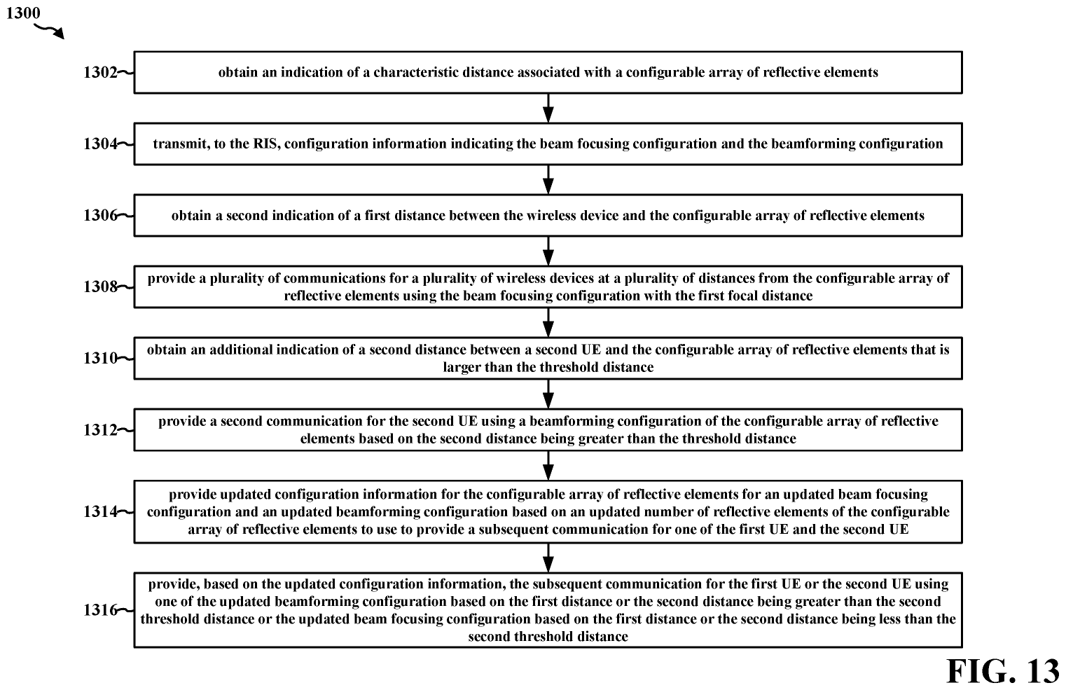

FIG. 13 is a flowchart 1300 of a method of wireless communication. The method may be performed by a network device that may be a base station in communication with one or more UEs via a RIS (e.g., the base station 102, 702, 902, 1002, 1003; the network entity 1602). At 1302, the network device may obtain a first set of attributes of the configurable array of reflective elements (e.g., from a RIS). For example, 1302 may be performed by CU processor 1612, DU processor 1632, RU processor 1642, transceiver(s) 1646, antenna(s) 1680, and/or single-point beam focusing component 199 of FIG. 16. In some aspects, obtaining the first set of attributes may include receiving the first set of attributes from a RIS (or RIS controller) corresponding to providing the first set of attributes from a RIS at 1202. The first set of attributes, in some aspects, may include one or more of an aperture size of the configurable array of reflective elements, a reflective element size (or area), a number of reflective elements, or an inter-element spacing of the configurable array of reflective elements. For example, referring to FIG. 10, the base stations 1002 and 1003 may receive, e.g., from the RIS 1006, indication 1010 of a set of RIS attributes (e.g., an aperture size, an element size, a number of elements, an element spacing, etc.) that affects the optimum beam focusing distance (e.g., a characteristic distance associated with the RIS) for a beam focusing configuration in both, or either, of a single-distance beam focusing mode of operation or a dual-RIS-configuration mode of operation and may affect a near-field boundary distance (e.g., an additional characteristic distance) associated with a dual-RIS-configuration mode of operation.

At 1304, the network device may provide an indication of a characteristic distance associated with the configurable array of reflective elements (e.g., the RIS). For example, 1304 may be performed by CU processor 1612, DU processor 1632, RU processor 1642, transceiver(s) 1646, antenna(s) 1680, and/or single-point beam focusing component 199 of FIG. 16. In some aspects, providing the indication of the characteristic distance includes transmitting to a RIS, configuration information for a beam focusing configuration with a first focusing distance based on the first set of attributes obtained, e.g., received, at 1302. In some aspects, providing the indication of a characteristic distance may include transmitting, from the network device (e.g., a base station) to a RIS, phase-matrix configuration information indicating a first phase matrix associated with a beam focusing configuration and a second phase matrix associated with a beamforming configuration. For example, referring to FIG. 10, the RIS 1006 may receive the set of RIS configurations 1014 and 1016 from the base stations 1002 and 1003, respectively.

In some aspects, obtaining the indication of the characteristic distance associated with the configurable array of reflective elements includes determining, the characteristic distance based on a first set of attributes of the configurable array of reflective elements and a second set of attributes of the communication. In some aspects, the characteristic distance may be based on one or more of a number of reflective elements associated with the configurable array of reflective elements, an area of each reflective element associated with the configurable array of reflective elements, a wavelength associated with the plurality of communications, a first elevation angle associated with an incident transmission, a second elevation angle associated with a reflected incident transmission, and a distance from the configurable array of reflective elements to the network device using the configurable array of reflective elements to transmit a plurality of communications (e.g., as described below in relation to providing a plurality of communications for a plurality of wireless devices at 1308). For example, referring to FIG. 10, the first base station 1002 and the second base station 1003 may each, at 1012, determine a mode of operation (e.g., single-distance beam focusing or dual-RIS-configuration) and one or more associated RIS configurations for beam shaping (e.g., either beam focusing or beamforming) communications between a base station and one or more UEs, e.g., UE 1004, UE 1005, and UE 1009, based on the RIS attributes received in the indication 1010.

At 1306, the network device may obtain a second indication of a first distance between the wireless device and the configurable array of reflective elements. For example, 1306 may be performed by CU processor 1612, DU processor 1632, RU processor 1642, transceiver(s) 1646, antenna(s) 1680, and/or single-point beam focusing component 199 of FIG. 16. Referring to FIG. 10, for example, the network device may exchange location determination signals (e.g., position reference signals for determining a location/position including an associated angle and distance, or beam swept reference signals for determining an associated angle or angular position without acquiring distance information) with one or more of the UEs 1004, 1005, or 1009 to acquire location information sufficient for a selected mode of operation. In other examples, the first base station 1002 or the second base station 1003 may receive the information from the RIS 1006 or in another manner.

At 1308, the network device may provide a plurality of communications for a plurality of wireless devices at a plurality of distances from the configurable array of reflective elements using the beam focusing configuration with the first focusing distance. For example, 1308 may be performed by CU processor 1612, DU processor 1632, RU processor 1642, transceiver(s) 1646, antenna(s) 1680, and/or single-point beam focusing component 199 of FIG. 16. In some aspects, providing the plurality of communications at 1208, may include providing a communication for a wireless device using a beam focusing configuration provided to the configurable array of reflective elements with a first focusing distance based on the characteristic distance. In some aspects, the first focusing distance may be based on a first set of attributes of the configurable array of reflective elements and a second set of attributes of the communication. The first set of attributes, as discussed above, may include one or more of an aperture size of the configurable array of reflective elements or an inter-element spacing of the configurable array of reflective elements, and the second set of attributes may include a frequency associated with the communication. In some aspects, beam focusing may include directional beamforming and additional focusing of a directional beam. For example, referring to FIG. 10, the first base station 1002 may transmit transmissions 1022, 1023, or 1025, and the second base station 1003 may transmit transmissions 1034, 1036, 1043, or 1044 to be beam focused by RIS 1006 to provide the transmission to one of UE 1004, 1005, or 1009.

At 1310, the network device may obtain an additional indication of a second distance between a second UE and the configurable array of reflective elements that is larger than the threshold distance. For example, 1310 may be performed by CU processor 1612, DU processor 1632, RU processor 1642, transceiver(s) 1646, antenna(s) 1680, and/or single-point beam focusing component 199 of FIG. 16. Referring to FIG. 10, for example, the network device may exchange location determination signals (e.g., position reference signals for determining a location/position including an associated angle and distance, or beam swept reference signals for determining an associated angle or angular position without acquiring distance information) with an additional UE of the one or more of the UEs 1004, 1005, or 1009 to acquire location information sufficient for a selected mode of operation. In other examples, the first base station 1002 or the second base station 1003 may receive the information from the RIS 1006 or in another manner.

At 1312, the network device may provide a second communication for the second UE using a beamforming configuration of the configurable array of reflective elements based on the second distance being greater than the threshold distance. For example, 1312 may be performed by CU processor 1612, DU processor 1632, RU processor 1642, transceiver(s) 1646, antenna(s) 1680, and/or single-point beam focusing component 199 of FIG. 16. In some aspects, the beamforming configuration may be associated with directional beamforming without additional focusing of the directional beam. For example, referring to FIG. 10, the second base station 1003 may transmit transmission 1032 to be beamformed by RIS 1006 to provide the transmission to UE 1004.

At 1314, the network device may provide updated configuration information for the configurable array of reflective elements for an updated beam focusing configuration and an updated beamforming configuration based on an updated number of reflective elements of the configurable array of reflective elements to use to provide a subsequent communication for one of the first UE and the second UE. For example, 1314 may be performed by CU processor 1612, DU processor 1632, RU processor 1642, transceiver(s) 1646, antenna(s) 1680, and/or single-point beam focusing component 199 of FIG. 16. In some aspects, a second threshold distance associated with the updated configuration information may be one of less than the first distance (associated with the first wireless device) or greater than the second distance (associated with the second wireless device) based on the updated number of reflective elements. For example, referring to FIG. 10, the base station may provide a request or indication 1041 to update a RIS configuration, that may be associated with a near-field boundary, d′_{NF} (or d″_{NF}), that is one of less than a first distance to the UE 1009 or greater than a second distance to the UE 1004.

At 1316, the network device may provide, based on the updated configuration information, the subsequent communication for the first UE or the second UE using one of the updated beamforming configuration based on the first distance or the second distance being greater than the second threshold distance or the updated beam focusing configuration based on the first distance or the second distance being less than the second threshold distance. For example, 1316 may be performed by CU processor 1612, DU processor 1632, RU processor 1642, transceiver(s) 1646, antenna(s) 1680, and/or single-point beam focusing component 199 of FIG. 16. Referring to FIG. 10, for example, the base station provide transmissions 1043 and 1044 to use one of a beamforming configuration if an updated near-field boundary, d′_{NF}, is smaller than the distance to the UEs 1004 and 1005, or using a beam focusing configuration if an updated near-field boundary, d″_{NF}, is larger than the distance to the UEs 1004 and 1005.

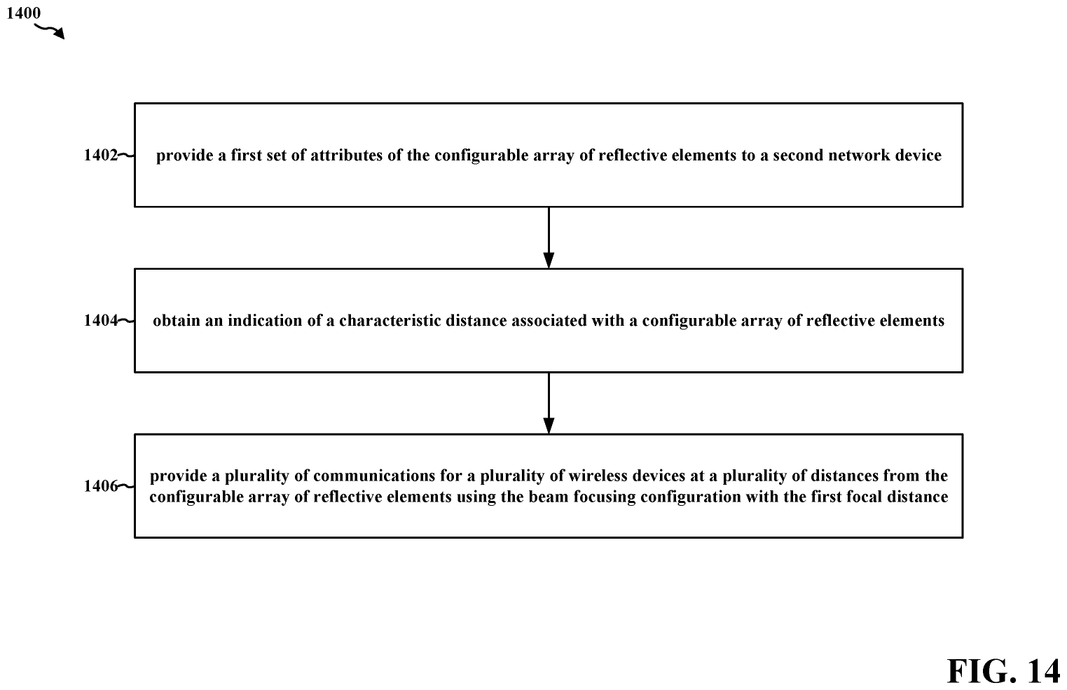

FIG. 14 is a flowchart 1400 of a method of wireless communication. The method may be performed by a network device that may be one of a RIS (e.g., a configurable array of reflective elements), a RIS controller, or a device including a RIS controller and a RIS (e.g., the RIS 103, 706, 806, 906, 1006, or 1740; the RIS controller 108, 708, or 908; the controller 1741; the network entity 1602). For clarity, the network device will be referred to as a RIS for the discussion of FIG. 14. At 1402, the RIS may provide a first set of attributes of the configurable array of reflective elements to a second network device. For example, 1402 may be performed by controller 1741, processor 1742, transceiver(s) 1746, and/or single-point beam focusing component 199 of FIG. 17. For example, referring to FIG. 10, the RIS 1006 may transmit, and the base stations 1002 and 1003 may receive indication 1010 of a set of RIS attributes (e.g., an aperture size, an element size, a number of elements, an element spacing, etc.) that affects the optimum beam focusing distance (e.g., a characteristic distance associated with the RIS) for a beam focusing configuration in both, or either, of a single-distance beam focusing mode of operation or a dual-RIS-configuration mode of operation and may affect a near-field boundary distance (e.g., an additional characteristic distance) associated with a dual-RIS-configuration mode of operation.

At 1404, the network device may obtain an indication of a characteristic distance associated with a configurable array of reflective elements. For example, 1404 may be performed by controller 1741, processor 1742, transceiver(s) 1746, and/or single-point beam focusing component 199 of FIG. 17. In some aspects, obtaining an indication of a characteristic distance may include receiving, from the second network device, configuration information for the beam focusing configuration with the first focusing distance based on providing the first set of attributes to the second network device at 1402. In some aspects, the configuration may include phase-matrix configuration information indicating the first phase matrix associated with the beam focusing configuration. Referring to FIG. 10, for example, the RIS may receive the set of RIS configurations 1016 from the first base station 1002 for a set of single-distance RIS beam focusing operations 1020.

At 1406, the network device may provide a plurality of communications for a plurality of wireless devices at a plurality of distances from the configurable array of reflective elements using the beam focusing configuration with the first focusing distance. For example, 1402 may be performed by controller 1741, processor 1742, transceiver(s) 1746, passive antenna array 1780, RIS surface 1790, and/or single-point beam focusing component 199 of FIG. 17. In some aspects, providing the plurality of communications at 1406, may include providing a communication for a wireless device using a beam focusing configuration of the configurable array of reflective elements with a first focusing distance based on the characteristic distance. In some aspects, the first focusing distance may be based on a first set of attributes of the configurable array of reflective elements and a second set of attributes of the communication. The first set of attributes, as discussed above, may include one or more of an aperture size of the configurable array of reflective elements or an inter-element spacing of the configurable array of reflective elements, and the second set of attributes may include a frequency associated with the communication. In some aspects, the characteristic distance may be based on one or more of a number of reflective elements associated with the configurable array of reflective elements, an area of each reflective element associated with the configurable array of reflective elements, a wavelength associated with the plurality of communications, a first elevation angle associated with an incident transmission, a second elevation angle associated with a reflected incident transmission, and a distance from the configurable array of reflective elements to a transmitter device (e.g., a network device or base station) transmitting a plurality of communications via the configurable array of reflective elements. In some aspects, beam focusing may include directional beamforming and additional focusing of a directional beam. In some aspects, providing the first communication may include reflecting the first communication from the RIS for reflection to the first UE based on the beam focusing configuration. For example, referring to FIG. 10, the RIS 1006 may provide the transmissions 1022, 1023, and 1025 to UEs 1004, 1005, and 1009, respectively using a single-distance beam focusing RIS configuration.

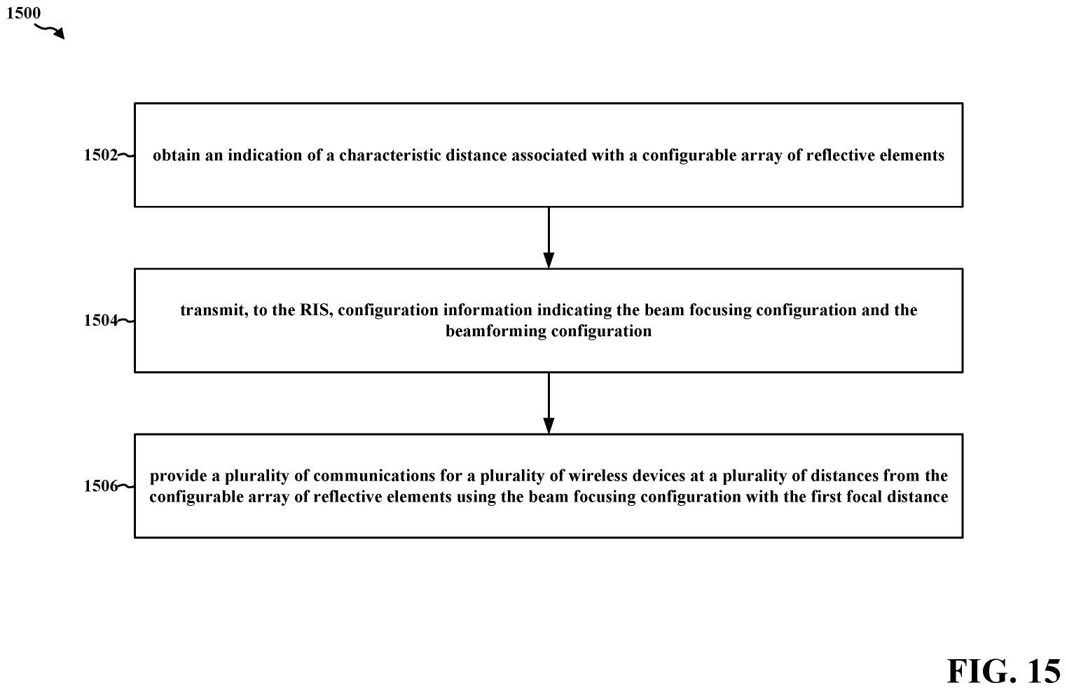

FIG. 15 is a flowchart 1500 of a method of wireless communication. The method may be performed by a network device that may be a base station in communication with one or more UEs via a RIS (e.g., the base station 102, 702, 902, 1002, 1003; the network entity 1602). At 1502, the base station may obtain an indication of a characteristic distance associated with a configurable array of reflective elements. For example, 1202 may be performed by CU processor 1612, DU processor 1632, RU processor 1642, transceiver(s) 1646, antenna(s) 1680, and/or single-point beam focusing component 199 of FIG. 16. In some aspects, obtaining an indication of a characteristic distance may include receiving first set of attributes of the configurable array of reflective elements from the RIS. For example, referring to FIG. 10, the first base station 1002 or the second base station 1003 may receive indication 1010 of a set of RIS attributes (e.g., an aperture size, an element size, a number of elements, an element spacing, etc.) that affects the optimum beam focusing distance (e.g., a characteristic distance associated with the RIS) for a beam focusing configuration in both, or either, of a single-distance beam focusing mode of operation or a dual-RIS-configuration mode of operation and may affect a near-field boundary distance (e.g., an additional characteristic distance) associated with a dual-RIS-configuration mode of operation.

At 1504, the base station may transmit, to the RIS, configuration information indicating the beam focusing configuration and the beamforming configuration. For example, 1504 may be performed by CU processor 1612, DU processor 1632, RU processor 1642, transceiver(s) 1646, antenna(s) 1680, and/or single-point beam focusing component 199 of FIG. 16. In some aspects, the configuration may include phase-matrix configuration information indicating the first phase matrix associated with the beam focusing configuration. Referring to FIG. 10, for example, the first base station 1002 and/or the second base station 1003 may transmit the set of RIS configurations 1014 and/or 1016, respectively, to RIS 1006.

At 1506, the base station may provide a plurality of communications for a plurality of wireless devices at a plurality of distances from the configurable array of reflective elements using the beam focusing configuration with the first focusing distance. For example, 1506 may be performed by CU processor 1612, DU processor 1632, RU processor 1642, transceiver(s) 1646, antenna(s) 1680, and/or single-point beam focusing component 199 of FIG. 16. In some aspects, providing the plurality of communications at 1506, may include providing a communication for a wireless device using a beam focusing configuration of the configurable array of reflective elements with a first focusing distance based on the characteristic distance. In some aspects, the first focusing distance may be based on a first set of attributes of the configurable array of reflective elements and a second set of attributes of the communication. The first set of attributes, as discussed above, may include one or more of an aperture size of the configurable array of reflective elements or an inter-element spacing of the configurable array of reflective elements, and the second set of attributes may include a frequency associated with the communication. In some aspects, the characteristic distance may be based on one or more of a number of reflective elements associated with the configurable array of reflective elements, an area of each reflective element associated with the configurable array of reflective elements, a wavelength associated with the plurality of communications, a first elevation angle associated with an incident transmission, a second elevation angle associated with a reflected incident transmission, and a distance from the configurable array of reflective elements to the base station transmitting the plurality of communications via the configurable array of reflective elements. In some aspects, beam focusing may include directional beamforming and additional focusing of a directional beam. In some aspects, providing the first communication may include transmitting the first communication to the RIS for reflection to the first UE based on the beam focusing configuration. For example, referring to FIG. 10, the first base station 1002 may transmit transmissions 1022, 1023, or 1025, and the second base station 1003 may transmit transmissions 1043 or 1044 to be beam focused by RIS 1006 to provide the transmission to one of UE 1004, 1005, or 1009.

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the single-point beam focusing component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include a CU processor 1612. The CU processor 1612 may include on-chip memory 1612′. In some aspects, the CU 1610 may further include additional memory modules 1614 and a communications interface 1618. The CU 1610 communicates with the DU 1630 through a midhaul link, such as an F1 interface. The DU 1630 may include a DU processor 1632. The DU processor 1632 may include on-chip memory 1632′. In some aspects, the DU 1630 may further include additional memory modules 1634 and a communications interface 1638. The DU 1630 communicates with the RU 1640 through a fronthaul link. The RU 1640 may include an RU processor 1642. The RU processor 1642 may include on-chip memory 1642′. In some aspects, the RU 1640 may further include additional memory modules 1644, one or more transceivers 1646, antennas 1680, and a communications interface 1648. The RU 1640 communicates with the UE 104. The on-chip memory 1612′, 1632′, 1642′ and the additional memory modules 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the single-point beam focusing component 199 may be configured to obtain an indication of a characteristic distance associated with a configurable array of reflective elements. The single-point beam focusing single-point beam focusing component 199 may also be configured to provide a communication for a wireless device using a beam focusing configuration of the configurable array of reflective elements with a first focusing distance based on the characteristic distance. The single-point beam focusing component 199 may be within one or more processors of one or more of the CU 1610, DU 1630, and the RU 1640. The single-point beam focusing component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1602 may include a variety of components configured for various functions. In one configuration, the network entity 1602 may include means for obtaining an indication of a characteristic distance associated with a configurable array of reflective elements. The network entity 1602 may include means for providing a communication for a wireless device using a beam focusing configuration of the configurable array of reflective elements with a first focusing distance based on the characteristic distance. The network entity 1602 may include means for obtaining a second indication of a first distance between the wireless device and the configurable array of reflective elements. The network entity 1602 may include means for obtaining an additional indication of a second distance between a second UE and the configurable array of reflective elements that is larger than the threshold distance. The network entity 1602 may include means for providing a second communication for the second UE using a beamforming configuration of the configurable array of reflective elements based on the second distance being greater than the threshold distance. The network entity 1602 may include means for obtaining updated configuration information for the configurable array of reflective elements for an updated beam focusing configuration and an updated beamforming configuration based on an updated number of reflective elements of the configurable array of reflective elements to use to provide a subsequent communication for one of the first UE and the second UE. The network entity 1602 may include means for providing, based on the updated configuration information, the subsequent communication for the first UE or the second UE using one of the updated beamforming configuration based on the first distance or the second distance being greater than the second threshold distance or the updated beam focusing configuration based on the first distance or the second distance being less than the second threshold distance. The network entity 1602 may include means for transmitting, to the RIS, configuration information indicating the beam focusing configuration and the beamforming configuration. The network entity 1602 may include means for transmitting the first communication to the RIS for reflection to the first UE based on the beam focusing configuration. The network entity 1602 may include means for transmitting the first communication to the RIS for reflection to the second UE based on the beamforming configuration. The network entity 1602 may include means for providing a plurality of communications for a plurality of wireless devices at a plurality of distances from the configurable array of reflective elements using the beam focusing configuration with the first focusing distance. The means may be the single-point beam focusing component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means or as described in relation to FIGS. 11, 13, and 15.

FIG. 17 is a diagram 1700 illustrating an example of a hardware implementation for a RIS 1740. The RIS 1740 includes a RIS surface 1790 that includes a passive antenna array 1780. The RIS surface 1790 includes a surface with a large number of densely placed reconfigurable elements that can reflect or refract an electromagnetic wave in target directions. FIG. 17 illustrates an example of the RIS surface 1790 reflecting communication between a UE 104 and a base station 102. The RIS 1740 includes a controller 1741 that controls an incident angle and an angle of reflection, e.g., by controlling reflection coefficients of (or phase shifts introduced by) the antenna elements of the RIS surface 1790. The controller 1741 may exchange communication, including control signaling or other signaling with a network node such as a base station 102 or a component of a base station 102 and/or a UE 104. The controller 1741 may exchange the communication via at least one transceiver 1746. The controller 1741 may include a processor 1742. The processor 1742 may include on-chip memory 1742′. In some aspects, the controller 1741 may further include additional memory modules 1744. The on-chip memory 1742′ and the additional memory modules 1744 may each be considered a computer-readable medium/memory. Each computer-readable medium/memory may be non-transitory. The processor 1742 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the single-point beam focusing component 199 that may be configured to obtain an indication of a characteristic distance associated with a configurable array of reflective elements. The single-point beam focusing component 199 may also be configured to provide a communication for a wireless device using a beam focusing configuration of the configurable array of reflective elements with a first focusing distance based on the characteristic distance. The single-point beam focusing component 199 may be within the processor 1742. The single-point beam focusing component 199 may be one or more hardware components specifically configured to carry out the stated processes/algorithm, implemented by one or more processors configured to perform the stated processes/algorithm, stored within a computer-readable medium for implementation by one or more processors, or some combination thereof. The RIS 1740 may include a variety of components configured for various functions. In one configuration, the RIS 1740 may include means for obtaining an indication of a characteristic distance associated with a configurable array of reflective elements. The RIS 1740 may include means for providing a communication for a wireless device using a beam focusing configuration of the configurable array of reflective elements with a first focusing distance based on the characteristic distance. The RIS 1740 may include means for obtaining a second indication of a first distance between the wireless device and the configurable array of reflective elements. The RIS 1740 may include means for obtaining an additional indication of a second distance between a second UE and the configurable array of reflective elements that is larger than the threshold distance. The RIS 1740 may include means for providing a second communication for the second UE using a beamforming configuration of the configurable array of reflective elements based on the second distance being greater than the threshold distance. The RIS 1740 may include means for obtaining updated configuration information for the configurable array of reflective elements for an updated beam focusing configuration and an updated beamforming configuration based on an updated number of reflective elements of the configurable array of reflective elements to use to provide a subsequent communication for one of the first UE and the second UE. The RIS 1740 may include means for providing, based on the updated configuration information, the subsequent communication for the first UE or the second UE using one of the updated beamforming configuration based on the first distance or the second distance being greater than the second threshold distance or the updated beam focusing configuration based on the first distance or the second distance being less than the second threshold distance. The RIS 1740 may include means for receiving, from a network node, phase-matrix configuration information indicating the first phase matrix and the second phase matrix. The RIS 1740 may include means for providing a first set of attributes of the configurable array of reflective elements to a second network device. The RIS 1740 may include means for receiving, from the second network device, configuration information for the beam focusing configuration with the first focusing distance based on providing the first set of attributes to the second network device. The RIS 1740 may include means for determining, at the configurable array of reflective elements, the characteristic distance based on a first set of attributes of the configurable array of reflective elements and a second set of attributes of the communication. The RIS 1740 may include means for providing a plurality of communications for a plurality of wireless devices at a plurality of distances from the configurable array of reflective elements using the beam focusing configuration with the first focusing distance. The means may be the single-point beam focusing component 199 of the RIS 1740 configured to perform the functions recited by the means or as described in relation to FIGS. 11, 12, and 14.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only. A and B, A and C, B and C, or A and B and C, where any such combinations may contain one or more member or members of A, B, or C. Sets should be interpreted as a set of elements where the elements number one or more. Accordingly, for a set of X. X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a network device, including obtaining an indication of a characteristic distance associated with a configurable array of reflective elements; and providing a communication for a wireless device using a beam focusing configuration of the configurable array of reflective elements with a first focusing distance based on the characteristic distance.
Aspect 2 is the method of aspect 1, where the indication is a first indication, the method further including obtaining a second indication of a first distance between the wireless device and the configurable array of reflective elements, where providing the communication using the beam focusing configuration of the configurable array of reflective elements with the first focusing distance is based on the first distance between the wireless device and the configurable array of reflective elements being less than a threshold distance.
Aspect 3 is the method of aspect 2, where the wireless device is a first user equipment (UE) in a first angular region around the configurable array of reflective elements, and where the communication is a first communication, the method further including obtaining an additional indication of a second distance between a second UE and the configurable array of reflective elements that is larger than the threshold distance; and providing a second communication for the second UE using a beamforming configuration of the configurable array of reflective elements based on the second distance being greater than the threshold distance.
Aspect 4 is the method of aspect 3, where the second UE is in the first angular region around the configurable array of reflective elements.
Aspect 5 is the method of any of aspects 3 and 4, further including obtaining updated configuration information for the configurable array of reflective elements for an updated beam focusing configuration and an updated beamforming configuration based on an updated number of reflective elements of the configurable array of reflective elements to use to provide a subsequent communication for one of the first UE and the second UE, where a second threshold distance associated with the updated configuration information is one of less than the first distance or greater than the second distance based on the updated number of reflective elements; and providing, based on the updated configuration information, the subsequent communication for the first UE or the second UE using one of the updated beamforming configuration based on the first distance or the second distance being greater than the second threshold distance or the updated beam focusing configuration based on the first distance or the second distance being less than the second threshold distance.
Aspect 6 is the method of any of aspects 3 to 5, where the beam focusing configuration is associated with a first phase matrix and the beamforming configuration is associated with a second phase matrix, and where the network device includes a reconfigurable intelligent surface (RIS) including the configurable array of reflective elements the method further including receiving, from a network node, phase-matrix configuration information indicating the first phase matrix and the second phase matrix.
Aspect 7 is the method of any of aspects 3 to 6, where the network device is at least a component of a base station and the configurable array of reflective elements is a reconfigurable intelligent surface (RIS), the method further including transmitting, to the RIS, configuration information indicating the beam focusing configuration and the beamforming configuration.
Aspect 8 is the method of aspect 7, where providing the first communication includes transmitting the first communication to the RIS for reflection to the first UE based on the beam focusing configuration, and where providing the second communication includes transmitting the first communication to the RIS for reflection to the second UE based on the beamforming configuration.
Aspect 9 is the method of any of aspects 2 to 8, where the threshold distance from the configurable array of reflective elements is based on one or more of a number of reflective elements associated with the configurable array of reflective elements, an area of each reflective element associated with the configurable array of reflective elements, a wavelength associated with the communication, a first elevation angle associated with an incident transmission, and a second elevation angle associated with a reflected incident transmission.
Aspect 10 is the method of any of aspects 2 to 9, where the first focusing distance is based on a first set of attributes of the configurable array of reflective elements and a second set of attributes of the communication, where the first set of attributes includes one or more of an aperture size of the configurable array of reflective elements or an inter-element spacing of the configurable array of reflective elements, and where the second set of attributes includes a frequency associated with the communication.
Aspect 11 is the method of any of aspects 1 to 6, 9, and 10, where the network device includes a reconfigurable intelligent surface (RIS) including the configurable array of reflective elements, the method further including providing a first set of attributes of the configurable array of reflective elements to a second network device, where obtaining the indication of the characteristic distance associated with the configurable array of reflective elements includes receiving, from the second network device, configuration information for the beam focusing configuration with the first focusing distance based on providing the first set of attributes to the second network device.
Aspect 12 is the method of any of aspects 1 to 6, 9, and 10, where the network device includes a reconfigurable intelligent surface (RIS) including the configurable array of reflective elements, and where obtaining the indication of the characteristic distance associated with the configurable array of reflective elements includes determining, at the configurable array of reflective elements, the characteristic distance based on a first set of attributes of the configurable array of reflective elements and a second set of attributes of the communication.
Aspect 13 is the method of any of aspects 1 to 12, where the first focusing distance for the beam focusing configuration is independent of a first distance between the wireless device and the configurable array of reflective elements.
Aspect 14 is the method of any of aspects 1 to 13, further including providing a plurality of communications for a plurality of wireless devices at a plurality of distances from the configurable array of reflective elements using the beam focusing configuration with the first focusing distance.
Aspect 15 is the method of aspect 14, where the characteristic distance is based on one or more of a number of reflective elements associated with the configurable array of reflective elements, an area of each reflective element associated with the configurable array of reflective elements, a wavelength associated with the plurality of communications, a first elevation angle associated with an incident transmission, and a second elevation angle associated with a reflected incident transmission.
Aspect 16 is the method of any of aspects 14 and 15, where the characteristic distance is based on a distance from the configurable array of reflective elements to a transmitter device transmitting the plurality of communications, and wherein the transmitter device is one of the network device or a base station.
Aspect 17 is the method of any of aspects 14 to 16, where the plurality of wireless devices are associated with a same angular region around the configurable array of reflective elements.
Aspect 18 is the method of any of aspects 14 to 17, where the configurable array of reflective elements is a reconfigurable intelligent surface, and where beam focusing includes directional beamforming and additional focusing of a directional beam.
Aspect 19 is an apparatus for wireless communication at a device including a memory and at least one processor coupled to the memory and, based at least in part on information stored in the memory, the at least one processor is configured to implement any of aspects 1 to 18.
Aspect 20 is the method of aspect 19, further including a transceiver or an antenna coupled to the at least one processor.
Aspect 21 is an apparatus for wireless communication at a device including means for implementing any of aspects 1 to 18.
Aspect 22 is a computer-readable medium (e.g., a non-transitory computer-readable medium) storing computer executable code, where the code when executed by a processor causes the processor to implement any of aspects 1 to 18.

What is claimed is:

1. An apparatus for wireless communication at a network device, comprising:
a memory; and
at least one processor coupled to the memory and, based at least in part on information stored in the memory, the at least one processor is configured to:
obtain an indication of a characteristic distance associated with a configurable array of reflective elements; and
provide a communication for a wireless device using a beam focusing configuration of the configurable array of reflective elements with a first focusing distance based on the characteristic distance.

2. The apparatus of claim 1, wherein the indication is a first indication, the at least one processor further configured to:
obtain a second indication of a first distance between the wireless device and the configurable array of reflective elements, wherein the at least one processor is configured to provide the communication using the beam focusing configuration of the configurable array of reflective elements with the first focusing distance based on the first distance between the wireless device and the configurable array of reflective elements being less than a threshold distance.

3. The apparatus of claim 2, wherein the wireless device is a first user equipment (UE) in a first angular region around the configurable array of reflective elements, and wherein the communication is a first communication, the at least one processor further configured to:
obtain an additional indication of a second distance between a second UE and the configurable array of reflective elements that is larger than the threshold distance; and
provide a second communication for the second UE using a beamforming configuration of the configurable array of reflective elements based on the second distance being greater than the threshold distance.

4. The apparatus of claim 3, wherein the second UE is in the first angular region around the configurable array of reflective elements.

5. The apparatus of claim 3, the at least one processor further configured to:
obtain updated configuration information for the configurable array of reflective elements for an updated beam focusing configuration and an updated beamforming configuration based on an updated number of reflective elements of the configurable array of reflective elements to use to provide a subsequent communication for one of the first UE and the second UE, wherein a second threshold distance associated with the updated configuration information is one of less than the first distance or greater than the second distance based on the updated number of reflective elements; and
provide, based on the updated configuration information, the subsequent communication for the first UE or the second UE using one of the updated beamforming configuration based on the first distance or the second distance being greater than the second threshold distance or the updated beam focusing configuration based on the first distance or the second distance being less than the second threshold distance.

6. The apparatus of claim 3, wherein the beam focusing configuration is associated with a first phase matrix and the beamforming configuration is associated with a second phase matrix, and wherein the network device comprises a reconfigurable intelligent surface (RIS) comprising the configurable array of reflective elements the at least one processor further configured to:
receive, from a network node, phase-matrix configuration information indicating the first phase matrix and the second phase matrix.

7. The apparatus of claim 3, wherein the network device is at least a component of a base station and the configurable array of reflective elements is a reconfigurable intelligent surface (RIS), the at least one processor further configured to:
transmit, to the RIS, configuration information indicating the beam focusing configuration and the beamforming configuration.

8. The apparatus of claim 7, wherein to provide the first communication the at least one processor is configured to transmit the first communication to the RIS for reflection to the first UE based on the beam focusing configuration, and wherein to provide the second communication the at least one processor is configured to transmit the first communication to the RIS for reflection to the second UE based on the beamforming configuration.

9. The apparatus of claim 2, wherein the threshold distance from the configurable array of reflective elements is based on one or more of a number of reflective elements associated with the configurable array of reflective elements, an area of each reflective element associated with the configurable array of reflective elements, a wavelength associated with the communication, a first elevation angle associated with an incident transmission, and a second elevation angle associated with a reflected incident transmission.

10. The apparatus of claim 2, wherein the first focusing distance is based on a first set of attributes of the configurable array of reflective elements and a second set of attributes of the communication, wherein the first set of attributes comprises one or more of an aperture size of the configurable array of reflective elements or an inter-element spacing of the configurable array of reflective elements, and wherein the second set of attributes comprises a frequency associated with the communication.

11. The apparatus of claim 1, wherein the network device comprises a reconfigurable intelligent surface (RIS) comprising the configurable array of reflective elements, the at least one processor further configured to:
provide a first set of attributes of the configurable array of reflective elements to a second network device, wherein to obtain the indication of the characteristic distance associated with the configurable array of reflective elements the at least one processor is configured to receive, from the second network device, configuration information for the beam focusing configuration with the first focusing distance based on the first set of attributes provided to the second network device.

12. The apparatus of claim 1, wherein the network device comprises a reconfigurable intelligent surface (RIS) comprising the configurable array of reflective elements, and wherein to obtain the indication of the characteristic distance associated with the configurable array of reflective elements the at least one processor is configured to determine, at the configurable array of reflective elements, the characteristic distance based on a first set of attributes of the configurable array of reflective elements and a second set of attributes of the communication.

13. The apparatus of claim 1, wherein the first focusing distance for the beam focusing configuration is independent of a first distance between the wireless device and the configurable array of reflective elements.

14. The apparatus of claim 1, the at least one processor further configured to:
provide a plurality of communications for a plurality of wireless devices at a plurality of distances from the configurable array of reflective elements using the beam focusing configuration with the first focusing distance.

15. The apparatus of claim 14, wherein the characteristic distance is based on one or more of a number of reflective elements associated with the configurable array of reflective elements, an area of each reflective element associated with the configurable array of reflective elements, a wavelength associated with the plurality of communications, a first elevation angle associated with an incident transmission, and a second elevation angle associated with a reflected incident transmission.

16. The apparatus of claim 14, wherein the characteristic distance is based on a distance from the configurable array of reflective elements to a transmitter device transmitting the plurality of communications, wherein the transmitter device is one of the network device or a base station.

17. The apparatus of claim 14, wherein the plurality of wireless devices are associated with a same angular region around the configurable array of reflective elements.

18. The apparatus of claim 14, wherein the configurable array of reflective elements is a reconfigurable intelligent surface, and wherein beam focusing includes directional beamforming and additional focusing of a directional beam.

19. A method of wireless communication at a network device, comprising:
obtaining an indication of a characteristic distance associated with a configurable array of reflective elements; and
providing a communication for a wireless device using a beam focusing configuration of the configurable array of reflective elements with a first focusing distance based on the characteristic distance.

20. The method of claim 19, wherein the indication is a first indication, the method further comprising:
obtaining a second indication of a first distance between the wireless device and the configurable array of reflective elements, wherein providing the communication using the beam focusing configuration of the configurable array of reflective elements with the first focusing distance is based on the first distance between the wireless device and the configurable array of reflective elements being less than a threshold distance.

21. The method of claim 20, wherein the wireless device is a first user equipment (UE) in a first angular region around the configurable array of reflective elements, and wherein the communication is a first communication, the method further comprising:
obtaining an additional indication of a second distance between a second UE and the configurable array of reflective elements that is larger than the threshold distance; and
providing a second communication for the second UE using a beamforming configuration of the configurable array of reflective elements based on the second distance being greater than the threshold distance.

22. The method of claim 21, wherein the second UE is in the first angular region around the configurable array of reflective elements.

23. The method of claim 21, further comprising:
obtaining updated configuration information for the configurable array of reflective elements for an updated beam focusing configuration and an updated beamforming configuration based on an updated number of reflective elements of the configurable array of reflective elements to use to provide a subsequent communication for one of the first UE and the second UE, wherein a second threshold distance associated with the updated configuration information is one of less than the first distance or greater than the second distance based on the updated number of reflective elements; and
providing, based on the updated configuration information, the subsequent communication for the first UE or the second UE using one of the updated beamforming configuration based on the first distance or the second distance being greater than the second threshold distance or the updated beam focusing configuration based on the first distance or the second distance being less than the second threshold distance.

24. The method of claim 21, wherein the beam focusing configuration is associated with a first phase matrix and the beamforming configuration is associated with a second phase matrix, and wherein the network device comprises a reconfigurable intelligent surface (RIS) comprising the configurable array of reflective elements the method further comprising:
receiving, from a network node, phase-matrix configuration information indicating the first phase matrix and the second phase matrix.

25. The method of claim 21, wherein the network device is at least a component of a base station and the configurable array of reflective elements is a reconfigurable intelligent surface (RIS), the method further comprising:
transmitting, to the RIS, configuration information indicating the beam focusing configuration and the beamforming configuration, wherein providing the first communication comprises transmitting the first communication to the RIS for reflection to the first UE based on the beam focusing configuration, and wherein providing the second communication comprises transmitting the first communication to the RIS for reflection to the second UE based on the beamforming configuration.

26. The method of claim 20, wherein the threshold distance from the configurable array of reflective elements is based on one or more of a number of reflective elements associated with the configurable array of reflective elements, an area of each reflective element associated with the configurable array of reflective elements, a wavelength associated with the communication, a first elevation angle associated with an incident transmission, and a second elevation angle associated with a reflected incident transmission, and wherein the first focusing distance is based on a first set of attributes of the configurable array of reflective elements and a second set of attributes of the communication, wherein the first set of attributes comprises one or more of an aperture size of the configurable array of reflective elements or an inter-element spacing of the configurable array of reflective elements, and wherein the second set of attributes comprises a frequency associated with the communication.

27. The method of claim 19, wherein the network device comprises a reconfigurable intelligent surface (RIS) comprising the configurable array of reflective elements, the method further comprising:
providing a first set of attributes of the configurable array of reflective elements to a second network device, wherein obtaining the indication of the characteristic distance associated with the configurable array of reflective elements comprises receiving, from the second network device, configuration information for the beam focusing configuration with the first focusing distance based on providing the first set of attributes to the second network device.

28. The method of claim 19, wherein the network device comprises a reconfigurable intelligent surface (RIS) comprising the configurable array of reflective elements, and wherein obtaining the indication of the characteristic distance associated with the configurable array of reflective elements comprises determining, at the configurable array of reflective elements, the characteristic distance based on a first set of attributes of the configurable array of reflective elements and a second set of attributes of the communication.

29. The method of claim 19, wherein the first focusing distance for the beam focusing configuration is independent of a first distance between the wireless device and the configurable array of reflective elements.

30. The method of claim 19, further comprising:
providing a plurality of communications for a plurality of wireless devices at a plurality of distances from the configurable array of reflective elements using the beam focusing configuration with the first focusing distance, wherein the plurality of wireless devices is associated with a same angular region around the configurable array of reflective elements, wherein the characteristic distance is based on one or more of a number of reflective elements associated with the configurable array of reflective elements, an area of each reflective element associated with the configurable array of reflective elements, a wavelength associated with the plurality of communications, a first elevation angle associated with an incident transmission, a second elevation angle associated with a reflected incident transmission, and a distance from the configurable array of reflective elements to a transmitter device transmitting the plurality of communications, and wherein the transmitter device is one of the network device or a base station.
